(19) United States
(12) Patent Application Publication
(10) Pub. No.: US 2024/0199461 A1
(43) Pub. Date: Jun. 20, 2024

(54) WATER SOFTENER SYSTEM

(71) Applicant: NUVO RESIDENTIAL, LLC DBA NUVOH2O, Salt Lake City, UT (US)

(72) Inventor: Byron Laird WASHBURN, Fruit Heights, UT (US)

(21) Appl. No.: 18/555,099

(22) PCT Filed: Apr. 13, 2022
(86) PCT No.: PCT/US2022/024713

§ 371 Date: Oct. 12, 2023

Related U.S. Application Data
(60) Provisional application No. 63/174,133, filed on Apr. 13, 2021.

(51) Int. Cl. C02F 5/10; C02F 1/00; C02F 1/68

(52) U.S. Cl. CPC C02F 5/10; C02F 1/008; C02F 1/687; C02F 2201/005; C02F 2201/006; C02F 2209/42; C02F 2307/10

(57) ABSTRACT

A water treatment system for treating a water supply includes a tank, a dispenser, and a control system. The tank is in fluid communication with the water supply to receive a flow of water from the water supply. The dispenser configured to be coupled to the tank and configured to dispense a water treatment material into a storage reservoir of the tank. The control system is configured to produce a water treatment solution in the storage reservoir by combining the water and the water treatment material.

### CROSS REFERENCE TO RELATED APPLICATIONS

This application claims priority to and the benefit of U.S. Provisional Patent Application No. 63/174,133, filed 13 Apr. 2021, the disclosure of which is now expressly incorporated herein by reference.

### FIELD OF THE DISCLOSURE

The present disclosure relates generally to water treatment and more specifically to water treatment systems for reducing water hardness.

### BACKGROUND

Water softener or treatment systems are used to reduce concentrations of hard minerals in water supplies or the deposition of those hard minerals in the piping and fixtures through which water flows. The reduction of the hard minerals in the water can reduce scale build up and prolong the life of household appliances as well as industrial water systems.

In typical water treatment systems, the water supply may be introduced to a container or cartridge containing the water treatment material, such as softener salt. The water flows through the cartridge and contacts the water treatment material, which then reacts with hard minerals in the water to reduce the water hardness and prevent deposition on piping and fixtures.

Such water treatment systems may, however, cause the water treatment material itself to solidify if it sits stagnant for long periods of time. Once solidified in an aqueous environment, the water treatment material does not react as well with the water flowing through the system, reducing the effectiveness of the water treatment system. Therefore, it may be difficult to accurately and effectively treat the hard minerals without wasting large amounts of water treatment material.

### SUMMARY

The present disclosure may comprise one or more of the following features and combinations thereof.

A water treatment system for treating a water supply may comprise a tank, a dispenser, and a control system. The tank may be in fluid communication with the water supply to receive a flow of water from the water supply. The dispenser may be configured to be coupled to the tank and configured to dispense a water treatment material at a predetermined flow rate into a storage reservoir of the tank. The control system may be configured to produce a water treatment solution in the storage reservoir by combining the water and the water treatment material. The control system may be configured to dose the water supply with the water treatment solution from the storage reservoir.

In some embodiments, the tank may include a tank housing and a cartridge mount. The tank housing maybe formed to define the storage reservoir. The cartridge mount may be coupled the tank housing. The cartridge mount may be formed to include a tank opening arranged to open into the storage reservoir.

In some embodiments, the dispenser may be configured to be coupled to the cartridge mount of the tank. The dispenser may be configured to dispense the water treatment material at the predetermined flow rate into the storage reservoir of the tank through the tank opening in the cartridge mount.

In some embodiments, the control system may comprise a doser in fluid communication with the storage reservoir and the water supply and a controller coupled to the doser. The doser may be configured to dose the water supply with the water treatment solution. The controller may be configured to direct the doser to dose a predetermined amount of the water treatment solution into the water supply.

In some embodiments, the dispenser may comprise a cartridge and a dispensing system. The cartridge may be configured to store the water treatment material. The dispensing system may be configured to control the dispensing of the water treatment material through an opening of the cartridge at the predetermined flow rate.

In some embodiments, the cartridge may include a body and a neck coupled to the body. The body may be formed to include an interior storage region that stores the water treatment material. The neck may be formed to include the opening arranged to open into the interior storage region.

In some embodiments, the neck may be configured to couple to the cartridge mount of the tank. The dispensing system may be configured to control the dispensing of the water treatment material through the opening in the neck of the cartridge at the predetermined flow rate.

In some embodiments, the dispensing system may comprise an auger and a knob. The auger may extend through the body of the cartridge into the interior storage region and blocks off the opening of the cartridge to prevent the water treatment material from moving through the opening. The knob may be coupled to a first end of the auger located outside the interior storage region.

In some embodiments, the auger may be configured to rotate about an axis. The knob may be configured to be rotated by a user to cause the auger to rotate about the axis. This way, the auger may gather predetermined amounts of the water treatment material and transport the predetermined amounts of the water treatment material through the opening to dispense the water treatment material at the predetermined flow rate in the storage reservoir.

In some embodiments, the auger may comprise a shaft and a helical screw. The shaft may be shaped to include the first end, a second end spaced apart axially from the first end to define a length of the shaft, and an outer surface that extends between and interconnects the first end and the second end. The helical screw may be coupled to the outer surface of the shaft. The helical screw may extend radially outward from and circumferentially around the outer surface of the shaft along at least part of the length of the shaft. In some embodiments, a portion of the helical screw may be located in the opening of the neck to block the water treatment material from moving out of the interior storage region.

In some embodiments, the cartridge mount of the tank may comprises a gate. The gate may be configured to change between a closed position and an open position. In the closed position, the gate may close the tank opening and block access to the storage reservoir through the tank opening. In the open position, the gate may have moved away from the tank opening to allow access to the storage reservoir through the tank opening.

In some embodiments, the control system may further comprise a gate actuator coupled to the gate and a cartridge sensor coupled to the cartridge mount of the tank. The gate actuator may be configured to cause the gate to move between the closed position and the open position. The cartridge sensor may be configured to detect if the dispenser is coupled to the cartridge mount.

In some embodiments, the controller may be coupled to the gate actuator and the cartridge sensor. The controller may be configured to direct the gate actuator to move the gate to the open position if the cartridge sensor detects the dispenser is coupled to the cartridge mount of the tank.

In some embodiments, the control system may further comprise a first valve in fluid communication with the water supply and a tank inlet conduit in fluid communication between the first valve and the storage reservoir. The first valve may be configured to vary the flow of water from the water supply through the tank inlet conduit to the storage reservoir.

In some embodiments, the control system may further comprise a mixer. The mixer may be located in the storage reservoir. The mixer may be configured to mix the water treatment solution in the storage reservoir to prevent the water treatment solution from settling in the storage reservoir.

In some embodiments, the mixer may be a hydraulic mixer in fluid communication with the water supply downstream of the first valve. The flow of water downstream of the first valve through the hydraulic mixer may cause the hydraulic mixer to mix the water treatment solution in the storage reservoir.

In some embodiments, the control system may further comprise a second valve in fluid communication with the doser, a dosing conduit in fluid communication between the second valve and the storage reservoir, and a flushing conduit in fluid communication between the second valve and the storage reservoir. The second valve may be configured to change between a dosing position and a flushing position. In the dosing position, the second valve may allow a flow of the water treatment solution from the storage reservoir to the doser and block flow through the flushing conduit. In the flushing position, the second valve may allow flow through the flushing conduit and block flow through the dosing conduit.

In some embodiments, the control system may further comprise a level sensor. The level sensor may be located in the storage reservoir and may be coupled to the controller. The level sensor may be configured to measure a fill level of the water treatment solution in the storage reservoir. In some embodiments, the controller may be configured to direct the second valve to vary flow between the dosing conduit and the flushing conduit to the doser based on the fill level of the water treatment solution in the storage reservoir measured by the level sensor.

In some embodiments, the control system may further comprise a mixer. The mixer may be located in the storage reservoir. The mixer may be configured to mix the water treatment solution in the storage reservoir to prevent the water treatment solution from settling in the storage reservoir.

In some embodiments, the control system may further comprise a level sensor. The level sensor may be located in the storage reservoir and may be coupled to the controller. The level sensor may be configured to measure a fill level of the water treatment solution in the storage reservoir.

According to another aspect of the present disclosure, a dispenser adapted for use in a water treatment system to dispense a water treatment material into a reservoir of water may comprise a cartridge and a dispensing system. The cartridge may be configured to store the water treatment material. The dispensing system may be configured to control the dispensing of the water treatment material through an opening in the cartridge.

In some embodiments, the cartridge may include a body and a neck coupled to the body. The body may be formed to include an interior storage region that stores the water treatment material. The neck may be formed to include the opening arranged to open into the interior storage region. In some embodiments, the dispensing system may be configured to control the dispensing of the water treatment material through the opening in the neck of the cartridge.

In some embodiments, the dispensing system may include an auger and a knob. The auger may extend through the body of the cartridge into the interior storage region and blocks off the opening of the cartridge to prevent the water treatment material from moving through the opening. The knob may be coupled to a first end of the auger located outside the interior storage region.

In some embodiments, the auger may be configured to rotate about an axis. The knob may be configured to be rotated by a user to cause the auger to rotate about the axis. This way, the auger may gather predetermined amounts of the water treatment material and transport the predetermined amounts of the water treatment material through the opening to dispense the water treatment material at a predetermined flow rate out of the interior storage region.

In some embodiments, the auger of the dispensing system may comprise a shaft and a helical screw. The shaft may be shaped to include the first end, a second end spaced apart axially from the first end to define a length of the shaft, and an outer surface that extends between and interconnects the first end and the second end. The helical screw may be coupled to the outer surface of the shaft. The helical screw may extend radially outward from and circumferentially around the outer surface of the shaft along at least part of the length of the shaft.

In some embodiments, a portion of the helical screw may be located in the opening of the neck to block the water treatment material from moving out of the interior storage region. In some embodiments, the helical screw may extend along at least half the length of the shaft.

In some embodiments, the helical screw may be shaped to define fins. The fins may be spaced apart axially from each other relative to the axis.

According to another aspect of the present disclosure, a method of treating a water supply with a water treatment solution may comprise providing a tank in fluid communication with the water supply and a first dispenser.

In some embodiments, the tank may include a tank housing and a cartridge mount coupled the tank housing. The tank housing may be formed to define a reservoir. The cartridge mount may be formed to include a tank opening arranged to open into the reservoir.

In some embodiments, the first dispenser may be configured to be coupled to the cartridge mount of the tank. The first dispenser may be configured to dispense a water treatment material through the tank opening at a predetermined flow rate.

In some embodiments, the method may further comprise conducting a first flow of water into the reservoir of the tank. The method may further comprise detecting a first predetermined fill level of the liquid in the reservoir and stopping the conducting of the first flow of water into the reservoir when the first predetermined fill level is detected.

In some embodiments, the method may further comprise dispensing the water treatment material in the first dispenser through the tank opening into the water in the reservoir at the predetermined flow rate. The method may further comprise detecting a second predetermined fill level of the liquid in the reservoir and stopping the dispensing of the water treatment material into the reservoir when the second predetermined fill level is detected.

In some embodiments, the method may further comprise mixing the water and the water treatment material in the reservoir to produce the water treatment solution. The water treatment solution may be configured to react with hard minerals in the water supply to reduce in the hardness of the water supply. The method may further comprise dosing a predetermined amount of the water treatment solution into the water supply to reduce the hardness of the water supply.

In some embodiments, the method may further comprise detecting a third predetermined fill level of the liquid in the reservoir. The third predetermined fill level may correspond to the reservoir being empty.

In some embodiments, the method may further comprise conducting a second flow of water into the reservoir of the tank to flush out the reservoir after the third predetermined fill level is detected. The method may further comprise detecting the first predetermined fill level of the liquid in the reservoir and stopping the conducting of the second flow of water into the reservoir when the first predetermined fill level is detected.

In some embodiments, the method may further comprise dosing the water in the reservoir into the water supply so as to empty the reservoir for refiling with the water treatment solution. The method may further comprise detecting the third predetermined fill level in the reservoir and stopping the dosing of the water when the third predetermined fill level is detected.

In some embodiments, the method may further comprise repeating the steps of: conducting the first flow of water into the reservoir of the tank, detecting the first predetermined fill level of the liquid in the reservoir, stopping the conducting of the first flow of water into the reservoir when the first predetermined fill level is detected after the step of stopping the dosing of the water when the third predetermined fill level is detected.

In some embodiments, the method may further comprise removing the first dispenser coupled the cartridge mount of the tank that is empty and coupling a second dispenser that is full to the cartridge mount. The method may further comprise dispensing the water treatment material in the second dispenser through the tank opening into the water in the reservoir at the predetermined flow rate.

In some embodiments, the method may further comprise repeating the steps of: detecting the second predetermined fill level of the liquid in the reservoir, stopping the dispensing of the water treatment material into the reservoir when the second predetermined fill level is detected, mixing the water and the water treatment material in the reservoir to produce the water treatment solution, and dosing the predetermined amount of the water treatment solution into the water supply.

In some embodiments, the method may further comprise providing a control system. The control system may comprise a doser in fluid communication with the reservoir and a controller coupled to the doser. The doser may be configured to dose the water treatment solution into the water supply. The controller may be configured to direct the doser to dispense the predetermined amount of the water treatment solution into the water supply. In some embodiments, the water treatment material may be citric acid.

According to another aspect of the present disclosure, a water treatment system for treating a water supply may comprise a tank, a dispenser, and a control system. The tank may be in fluid communication with the water supply to receive a flow of water from the water supply. The dispenser may be configured to be coupled to the tank and configured to dispense a water treatment material into a storage reservoir of the tank. The control system may be configured to produce a water treatment solution in the storage reservoir by combining the water and the water treatment material. The control system may be configured to dose the water supply with the water treatment solution from the storage reservoir. In some embodiments, the water treatment material is citric acid.

In some embodiments, the tank may include a tank housing and a cartridge mount be coupled the tank housing. The tank housing may be formed to define the storage reservoir. The cartridge mount may be formed to include a passageway arranged to open into the storage reservoir.

In some embodiments, the control system may comprise a doser in fluid communication with the storage reservoir and the water supply and a controller coupled to the doser. The doser may be configured to dose the water supply with the water treatment solution. The controller may be configured to direct the doser to dose a predetermined amount of the water treatment solution into the water supply.

In some embodiments, the dispenser may comprise a cartridge and a dispensing system. The cartridge may be configured to store the water treatment material. The dispensing system may be configured to control the dispensing of the water treatment material from the cartridge.

In some embodiments, the cartridge may include a body and a neck coupled to the body. The body may be formed to include an interior storage region that stores the water treatment material. The neck may be formed to include an opening arranged to open into the interior storage region.

In some embodiments, the neck may bee configured to couple to the cartridge mount of the tank. The dispensing system may be configured to control the dispensing of the water treatment material through the opening in the neck of the cartridge.

In some embodiments, the dispensing system may comprise an upper valve coupled to the neck of the cartridge and a lower valve coupled to the upper valve opposite the cartridge. The upper valve may be arranged over the opening formed by the neck of the cartridge. The lower valve may be coupled to the upper valve at a pivot point. The lower valve may be configured to rotate about a rotation axis at the pivot point.

In some embodiments, the upper valve may be formed to include a plurality of upper openings. The plurality of upper openings may be spaced apart circumferentially about the rotation axis.

In some embodiments, the lower valve may be formed to include a plurality of lower openings. The plurality of lower openings may be spaced apart circumferentially about the rotation axis.

In some embodiments, the dispensing system may be configured to change between a closed orientation and an open orientation. In the closed orientation, the plurality of lower openings formed in the lower valve may be offset from the plurality of upper openings formed in the upper valve so that the plurality of lower openings and the plurality of upper openings are covered to prevent the water treatment material from dispensing through the opening in the neck of the cartridge. In the open orientation, the plurality of lower openings formed in the lower valve may be aligned with the plurality of upper openings formed in the upper valve to allow dispensing of the water treatment material through the opening in the neck of the cartridge.

In some embodiments, the cartridge mount of the tank may comprise a cartridge-mount housing, a gate, and a gate controller. The cartridge-mount housing may be coupled to the tank housing. The cartridge-mount housing may be formed to define the passageway in fluid communication with the storage reservoir. The gate may be mounted in the passageway of the cartridge-mount housing. The gate may be configured to change between a closed position in which the gate blocks as access to the storage reservoir through the passageway and an open position in which the gate allows access to the storage reservoir through the passageway. The gate controller may be coupled to the gate. The gate may be configured to control movement of the gate between the closed position and the open position.

In some embodiments, the gate controller of the cartridge mount may comprise a shaft, a gear, and a gear ring. The shaft may extend through the cartridge-mount housing along a shaft axis. The shaft may be configured to rotate about the shaft axis. The gear may be coupled to an end of the shaft for rotation therewith. The gear ring may be coupled to the cartridge-mount housing. The gear ring may be configured to rotate relative to the cartridge-mount housing about the rotation axis.

In some embodiments, the gear ring may be configured to rotate in a first direction about the rotation axis from a first position to a second position. In the first position, the gate may be in the closed position. In the second position, the gate may be in the open position.

In some embodiments, the gear ring may be configured to rotate in a second direction about the rotation axis from the second position to the first position. The second direction may be opposite the first direction.

In some embodiments, the gear may be formed to define teeth that mate with teeth formed on the gear ring. The teeth of the gear may mate with the teeth on the gear ring so that rotation of the gear ring about the rotation axis from the first position to the second position causes the shaft to rotate about the shaft axis to change the gate from the closed position to the open position.

In some embodiments, the control system may further comprise a cartridge-mount lock and a cartridge sensor. The cartridge-mount lock may be coupled the cartridge mount. The cartridge-mount lock may be configured to change between a locked position and an unlocked position. In the locked position, the cartridge-mount lock may engage of the gate controller to block rotation of the gate controller between the first position and the second position. In the unlocked position, the cartridge-mount lock may be spaced apart from the gate controller to allow rotation of the gate controller between the first position and the second position. The cartridge sensor may be coupled to the cartridge mount of the tank. The cartridge sensor may be configured to detect if the dispenser is coupled to the cartridge mount.

In some embodiments, the controller may be coupled to the cartridge-mount lock and the cartridge sensor. The controller may be configured to direct the cartridge-mount lock to move from the locked position to the unlocked position if the cartridge sensor detects the dispenser is coupled to the cartridge mount of the tank.

In some embodiments, the control system may further comprise an inlet valve in fluid communication with the water supply. The inlet valve may be configured to vary the flow of water from the water supply to the storage reservoir.

In some embodiments, the water treatment system may further comprise a tank inlet conduit in fluid communication with the water supply and the inlet valve, a fill conduit in fluid communication with the inlet valve and the storage reservoir, and a flush conduit in fluid communication with the inlet valve and the storage reservoir. The flush conduit may include a nozzle coupled to an end of the flush conduit. The nozzle may be configured to spray the flow of water from the water supply.

In some embodiments, the inlet valve may be configured to change between a fully closed position, a fill position, and a flush position. In the fully closed position, the inlet valve may block the flow of water through the fill conduit and the flush conduit to prevent water from being supplied to the storage reservoir. In the fill position, the inlet valve may direct the flow of water through the fill conduit and block the flow of water through the fill conduit. In the flush position, the inlet valve may direct the flow of water through the flush conduit and block the flow of water through the fill conduit.

In some embodiments, the control system may further comprise a level sensor located in the storage reservoir. The level sensor may be coupled to the controller. The level sensor may be configured to measure a fill level of the water treatment solution in the storage reservoir.

In some embodiments, the controller may be configured to direct the inlet valve to change between the fully closed position, the fill position, and the flush position. The controller may be configured to direct the inlet valve to change between the different positions based on the fill level of the water treatment solution in the storage reservoir measured by the level sensor.

In some embodiments, the control system may further comprise a mixer located in the storage reservoir. The mixer may be configured to mix the water treatment solution in the storage reservoir to prevent the water treatment solution from settling in the storage reservoir.

According to another aspect of the present disclosure, a dispenser assembly may be adapted for use in a water treatment system to dispense a water treatment material into a reservoir of water. The dispenser assembly may comprise a cartridge mount and a dispenser. The cartridge mount may be coupled to a tank included water treatment system. The dispenser may be configured to be selectively coupled to the cartridge mount.

In some embodiments, the dispenser may comprise a cartridge and a dispensing system. The cartridge may be configured to store the water treatment material. The dispensing system may be coupled to the cartridge. The dispenser may be configured to control the dispensing of the water treatment material.

In some embodiments, the cartridge may include a body and a neck. The body may be formed to include an interior storage region that stores the water treatment material. The neck may be coupled to the body. The neck may be formed to include an opening arranged to open into the interior storage region. The dispensing system may be configured to control the dispensing of the water treatment material through the opening in the neck of the cartridge.

In some embodiments, the dispenser may be configured to be inserted into the cartridge mount and rotated about a rotation axis in a first direction to cause the dispensing system to change from a closed orientation to an open orientation. In the closed orientation, the dispensing system may block the water treatment material from dispensing through the opening in the neck of the cartridge. In the open orientation, the dispensing system may have moved to allow the water treatment material to move through the opening of the cartridge to dispense the water treatment material out of the interior storage region into the reservoir of water and the water treatment material is citric acid.

In some embodiments, the dispensing system may comprise an upper valve coupled to the neck of the cartridge and a lower valve coupled to the upper valve opposite the cartridge. The upper valve may be arranged over the opening formed by the neck of the cartridge. The lower valve may be coupled to the upper valve at a pivot point. The lower valve may be configured to rotate about a rotation axis at the pivot point.

In some embodiments, the upper valve may be formed to include a plurality of upper openings spaced apart circumferentially about the rotation axis. In some embodiments, the lower valve may be formed to include a plurality of lower openings spaced apart circumferentially about the rotation axis.

In some embodiments, the plurality of lower openings formed in the lower valve may be offset from the plurality of upper openings formed in the upper valve when the dispensing system is in the closed orientation so that the plurality of lower openings and the plurality of upper openings are covered to prevent the water treatment material from dispensing through the opening in the neck of the cartridge. In some embodiments, the plurality of lower openings formed in the lower valve may be aligned with the plurality of upper openings formed in the upper valve when the dispensing system is in the open orientation to allow dispensing of the water treatment material through the opening in the neck of the cartridge.

In some embodiments, the upper valve may be formed to include a main body and spring arms. The main body may be formed to define the plurality of upper openings. Each of the spring arms may extend from the main body. Each of the spring arms may be configured to deflect axially relative to the rotation axis from an engaged position to a disengaged position. In the engaged position, each spring arm may engage the lower valve to block rotation of the lower valve while the lower valve is in the closed orientation. In the disengaged position, each spring arm may have deflected to allow rotation of the lower valve from the closed orientation to the open orientation.

In some embodiments, the lower valve may be formed to include a planar body, alignment pins, and guide slots. The planar body may be formed to include the plurality of lower openings. The alignment pins may each extend axially from the planar body away from the upper valve relative to the rotation axis. The guide slots may each extend axially through the planar body relative to the rotation axis and circumferentially at least part way about the rotation axis.

In some embodiments, each of the alignment pins may be configured to engage with the cartridge mount when the dispenser is inserted into the cartridge mount. Each of the alignment pins may be configured to engage the cartridge mount to fix the lower valve relative to the cartridge mount when the dispenser is inserted into the cartridge mount. In some embodiments, each of the guide slots may be configured to receive a portion of one of the spring arms.

In some embodiments, the cartridge mount may comprise a cartridge-mount housing, a gate, and a gate controller. The cartridge-mount housing may be formed to define a passageway in fluid communication with the reservoir of water included in the water treatment system. The gate may be mounted in the passageway of the cartridge-mount housing. The gate may be configured to change between a closed position in which the gate blocks as access through the passageway and an open position in which the gate allows access through the passageway. The gate controller may be coupled to the gate and configured to control movement of the gate between the closed position and the open position.

In some embodiments, the gate controller of the cartridge mount may comprise a shaft, a gear, and a gear ring. The shaft may extend through the cartridge-mount housing along a shaft axis. The shaft may be configured to rotate about the shaft axis. The gear may be coupled to an end of the shaft for rotation therewith. The gear ring may be coupled to the cartridge-mount housing. The gear ring may be configured to rotate relative to the cartridge-mount housing about the rotation axis.

In some embodiments, the gear ring may be configured to rotate in the first direction about the rotation axis from a first position to a second position. In the first position, the gate may be in the closed position. In the second position, the gate may be in the open position.

In some embodiments, the gear may be formed to define teeth that mate with teeth formed on the gear ring. The teeth of the gear and the gear ring may mate so that rotation of the gear ring about the rotation axis from the first position to the second position causes the shaft to rotate about the shaft axis to change the gate from the closed position to the open position.

In some embodiments, the dispenser may cooperate with the gate controller of the cartridge mount to control dispensing of the water treatment material. In this way, when the dispenser is rotated about the rotation axis in the first direction the dispenser may engage the gear ring of the gate controller to cause the gate controller to rotate from the first position to the second position thereby moving the gate from the closed position to the open position.

According to another aspect of the present disclosure, a method of treating a water supply with a water treatment solution may comprise providing a tank in fluid communication with the water supply and a first dispenser.

In some embodiments, the tank may include a tank housing and a cartridge mount coupled the tank housing. The tank housing may be formed to define a reservoir. The cartridge mount may be formed to include a tank opening arranged to open into the reservoir.

In some embodiments, the first dispenser may be configured to be coupled to the cartridge mount of the tank. The first dispenser may be configured to dispense a water treatment material through the tank opening.

In some embodiments, the method may further comprise conducting a first flow of water into the reservoir of the tank. The method may further comprise detecting a first predetermined fill level of the liquid in the reservoir and stopping the conducting of the first flow of water into the reservoir when the first predetermined fill level is detected.

In some embodiments, the method may further comprise dispensing the water treatment material in the first dispenser through the tank opening into the water in the reservoir. The method may further comprise detecting a second predetermined fill level of the liquid in the reservoir and mixing the water and the water treatment material in the reservoir when the second predetermined fill level is detected to produce the water treatment solution.

In some embodiments, the water treatment solution may be configured to react with hard minerals in the water supply to reduce in the hardness of the water supply. The method may further comprise dosing a predetermined amount of the water treatment solution into the water supply to reduce the hardness of the water supply.

In some embodiments, the method may further comprise detecting a third predetermined fill level of the liquid in the reservoir. The third predetermined fill level may correspond to the reservoir being empty.

In some embodiments, the method may further comprise conducting a second flow of water into the reservoir of the tank to flush out the reservoir after the third predetermined fill level is detected. The method may further comprise detecting a fourth predetermined fill level of the liquid in the reservoir and stopping the conducting of the second flow of water into the reservoir when the fourth predetermined fill level is detected.

In some embodiments, the method may further comprise dosing the water in the reservoir into the water supply so as to empty the reservoir for refiling with the water treatment solution. The method may further comprise detecting the third predetermined fill level in the reservoir and stopping the dosing of the water when the third predetermined fill level is detected.

In some embodiments, the method may further comprise repeating the steps of: conducting the first flow of water into the reservoir of the tank, detecting the first predetermined fill level of the liquid in the reservoir, stopping the conducting of the first flow of water into the reservoir when the first predetermined fill level is detected after the step of stopping the dosing of the water when the third predetermined fill level is detected.

In some embodiments, the method may further comprise removing the first dispenser coupled the cartridge mount of the tank that is empty and coupling a second dispenser that is full to the cartridge mount. The method may further comprise dispensing the water treatment material in the second dispenser through the tank opening into the water in the reservoir.

In some embodiments, the method may further comprise repeating the steps of: detecting the second predetermined fill level of the liquid in the reservoir, mixing the water and the water treatment material in the reservoir when the second predetermined fill level is detected to produce the water treatment solution, and dosing the predetermined amount of the water treatment solution into the water supply.

These and other features of the present disclosure will become more apparent from the following description of the illustrative embodiments.

### BRIEF DESCRIPTION OF THE DRAWINGS

FIG. 1 is an elevation view of a water treatment system for treating a water supply with a water treatment solution showing the water treatment system includes a system housing for covering the other components of the water treatment system;

FIG. 2 is a view similar to FIG. 1 showing the water treatment system with the system housing removed to show the water treatment system includes a tank in fluid communication with the water supply to receive a flow of water from the water supply, a dispenser coupled to a cartridge mount of the tank to dispense a water treatment material into a storage reservoir of the tank, and a control system that produces the water treatment solution in the storage reservoir by combining the water and the water treatment material and doses the water supply with the water treatment solution from the storage reservoir;

FIG. 3 is a view similar to FIG. 2 showing the control system included in the water treatment solution includes a doser in fluid communication with the storage reservoir and the water supply to dose the water supply with the water treatment solution, a valve system to vary the flow through the water treatment system, and a controller coupled to the doser and the valves to control the dosing of the water treatment solution into the water supply;

FIG. 4 is a diagrammatic view of the water treatment solution of FIG. 1 showing the water treatment system in a first stage of a fill mode in which the controller has directed the first valve coupled to an inlet of the tank to change to an open position in which the valve allows a flow of water from the water supply to fill the storage reservoir of the tank;

FIG. 5 is a diagrammatic view similar to FIG. 4 showing the water treatment system in a second stage of the fill mode in which the controller has directed the first valve to change to a closed position in which the valve blocks the flow of water from the water supply, and the empty dispenser is removed from the cartridge mount causing a gate of the cartridge mount to change from an open position as shown in FIG. 4 to a closed position in which the gate blocks access to the storage reservoir through the tank opening;

FIG. 6 is a diagrammatic view similar to FIG. 5 showing the water treatment system in a third stage of the fill mode in which the new full dispenser has been coupled to the cartridge mount causing the gate of the cartridge mount to change to the open position to allow a user to dispense citric acid contained in the dispenser into the water in the storage reservoir;

FIG. 7 is a diagrammatic view similar to FIG. 6 showing the water treatment system in a treatment mode in which a mixer included in the control system is directed to change from an off mode to an on mode so as to mix the water and the citric acid to form the water treatment solution and the doser is directed to dose controlled amounts of the water treatment solution into the water supply;

FIG. 8 is a diagrammatic view similar to FIG. 7 showing the water treatment system in a first stage of a flush mode in which the controller has directed the first valve to change to the open position to allow the flow of water from the water supply to fill the storage reservoir of the tank;

FIG. 9 is a diagrammatic view similar to FIG. 8 showing the water treatment system in a second stage of the flush mode in which the controller has directed the first valve to change to a closed position and the doser is directed to flush the storage reservoir by draining the water from the storage tank so that more water treatment solution may be created;

FIG. 10 is a cross-section view of the dispenser included in the water treatment solution of FIG. 1 showing the dispenser includes a cartridge configured to be coupled to the tank, the cartridge having a body to store the water treatment material and a neck coupled to the body to form an opening into the dispenser, and a dispensing system to control the dispensing of the water treatment material through the opening in the neck of the cartridge at the predetermined flow rate;

FIG. 11 is a view similar to FIG. 10 with the dispenser coupled to the cartridge mount of the tank showing the dispensing system included in the dispenser includes an auger that extends through the body of the cartridge into the interior storage region and blocks off the opening of the cartridge to prevent the water treatment material from moving through the opening and a knob coupled to a first end of the auger located outside the interior storage region and configured to be rotated to rotate the auger and cause the auger to dispense controlled amounts of the water treatment material through the opening;

FIG. 12 is elevation view of the dispenser of FIG. 10 showing the dispenser further includes a cap coupled to the neck of the cartridge;

FIG. 13 is a view similar to FIG. 12 showing the cap removed from the neck of the cartridge;

FIG. 14 is an elevation view of the control system included in the water treatment system of FIG. 1 showing the control system further includes a user interface that receives inputs from the user to control the mode of the system and is also configured to provide information and/or instructions to the user via sounds or lights;

FIG. 15A is a diagrammatic view of another embodiment of a water treatment system showing the water treatment system includes a tank in fluid communication with the water supply to receive a flow of water from the water supply, a dispenser coupled to a cartridge mount of the tank to dispense a water treatment material into a storage reservoir of the tank, and a control system that produces the water treatment solution in the storage reservoir by combining the water and the water treatment material and doses the water supply with the water treatment solution from the storage reservoir;

FIG. 15B is a view similar to FIG. 15A showing the control system includes a controller and a valve in communication with the controller and coupled to a tank inlet conduit to control the flow of water between a fill conduit to unrestrictedly fill the storage reservoir of the tank and a flush conduit with a spray nozzle to flush the storage reservoir between refills of the tank;

FIG. 15C is a view similar to FIG. 15B showing the control system further includes sensors, a mixer, and a UV light in communication with the controller, the sensors configured to measure the fill level of the water/solution in the storage reservoir of the tank, the mixer configured to mix the water treatment solution in the storage reservoir of the tank to prevent the water treatment solution from settling in the storage reservoir, the UV light configured to kill bacteria that may grow in the storage reservoir of the tank;

FIG. 16 is a diagrammatic view of the water treatment solution of FIG. 15A showing the water treatment system in a first stage of a fill mode in which the controller has directed the valve to change from a fully closed position in which the valve blocks a flow of water to the storage reservoir of the tank to a fill position in which the valve allows the flow of water from the water supply through the fill conduit to fill the storage reservoir of the tank;

FIG. 17 is a diagrammatic view similar to FIG. 16 showing the water treatment system in a second stage of the fill mode in which the controller has directed the valve to change to the fully closed position and the empty dispenser is removed from the cartridge mount causing a gate of the cartridge mount to change from an open position as shown in FIG. 29 to a closed position as shown in FIG. 28 in which the gate blocks access to the storage reservoir through the tank opening;

FIG. 18 is a diagrammatic view similar to FIG. 17 showing the water treatment system in a third stage of the fill mode in which the new full dispenser has been coupled to the cartridge mount causing the gate of the cartridge mount to change to the open position and causing the dispenser to dispense water treatment composition contained in the dispenser into the water in the storage reservoir;

FIG. 19 is a diagrammatic view similar to FIG. 18 showing the water treatment system in a fourth stage of the fill mode in which a mixer included in the control system is directed to change from an off mode to an on mode so as to mix the water and the water treatment composition to form the water treatment solution;

FIG. 20 is a diagrammatic view similar to FIG. 19 showing the water treatment system in a treatment mode in which the doser is directed to dose controlled amounts of the water treatment solution into the water supply;

FIG. 21 is a diagrammatic view similar to FIG. 20 showing the water treatment system in a first stage of a flush mode in which the controller has directed the valve to change to a flush position in which the valve allows the flow of water from the water supply through the flush conduit to spray the storage reservoir of the tank with water and flush out the storage reservoir;

FIG. 22 is a diagrammatic view similar to FIG. 21 showing the water treatment system in a second stage of the flush mode in which the controller has directed the valve to change to the fully closed position and the doser is directed to flush the storage reservoir by draining the water from the storage tank so that more water treatment solution may be created;

FIG. 23 is a perspective view of the dispenser included in the water treatment system of FIG. 15A showing the dispenser includes a cartridge configured to be coupled to the cartridge mount of the tank and a dispensing system coupled to an opening of the cartridge to control the dispensing of the water treatment material through the opening of the cartridge by changing between a closed orientation as shown in FIG. 23A and an open orientation as shown in FIG. 23B;

FIG. 23A is a detail view of the dispenser of FIG. 23 showing the dispensing system in the closed orientation in which openings are blocked to prevent the flow of the water treatment material therethrough;

FIG. 23B is a view similar to FIG. 23A showing the dispensing system has changed to the open orientation in which the openings are aligned to allow the flow of the water treatment material therethrough and out of the dispenser;

FIG. 24 is an exploded view of the dispenser of FIG. 23 showing the dispenser includes the cartridge, the dispensing system, and a cap configured to extend over the dispensing system and couple the a neck of the cartridge, the dispensing system including an upper valve configured to be coupled to the cartridge and a lower valve configured to be coupled to the upper valve at a pivot point;

FIG. 25 is a perspective view of the upper valve included in the dispenser of FIG. 24 showing the upper valve includes a main body formed to include a plurality of upper openings, engagement flanges that extend radially away from the main body on opposite sides of the main body relative to a cartridge/rotation axis, and spring arms that extend from the main body and are configured to deflect axially relative to the cartridge axis;

FIG. 25A is a detail view of FIG. 25 showing each spring arm is formed to include a locking pin that extends axially from a terminal end of the corresponding spring arm relative to the axis and each locking pin has a varying diameter;

FIG. 26 is a perspective view of the lower valve included in the dispenser of FIG. 24 showing the lower valve includes a planar body formed to include a plurality of lower openings that are configured to be aligned with the upper openings in the upper valve when in the open orientation, alignment pins that extend axially from a lower surface of the planar body away from the upper valve, and guide slots each configured to receive the locking pin of the corresponding spring arm of the upper valve to fix the upper and lower valves relative to each other and help guide the lower valve as it rotates relative to the upper valve;

FIG. 26A is a detail view of FIG. 26 showing each of the slots is formed to include a counterbore at one end of the guide slot and the counterbore has a greater diameter than the diameter of the corresponding guide slot that is equal to the larger diameter of the locking pin;

FIG. 27 is an exploded view of the cartridge mount included in tank of FIG. 15A showing the cartridge mount includes a cartridge-mount housing formed to include the passageway, a gate mounted in the passageway of the cartridge-mount housing to change between the closed position as shown in FIG. 28 and the open position as shown in FIG. 29, and a gate controller configured to control movement of the gate between the closed and open positions, and further showing the cartridge-mount housing includes a dispensing-system receiver adapted to receive the end of the cartridge with the dispensing system, a conduit configured to be coupled to the tank housing, and a grate configured to be arranged between the receiver and the conduit;

FIG. 28 is a perspective view of the cartridge mount of FIG. 27 showing the gate controller includes a gear coupled to the gate for rotation therewith and a gear ring coupled to the cartridge-mount housing, the gear formed to include teeth that mate with teeth of the gear ring, and the gear ring configured to rotate relative to the cartridge-mount housing about the axis of the cartridge between a first position as shown in FIG. 30 and a second position as shown in FIG. 31 to drive rotation of the gate between the closed and open positions;

FIG. 29 is a view similar to FIG. 28 showing the gear ring of the gate controller has rotated about the axis from the first position to the second position to cause the gate to change from the closed position to the open position;

FIG. 30 is a perspective view of the cartridge mount of FIG. 27 showing the dispensing-system receiver is shaped to include flange-receiving slots configured to receive the corresponding engagement flange of the upper valve, alignment pinholes configured to receive the corresponding alignment pin of the lower valve, and ribs configured to extend into the corresponding guide slot of the lower valve, and further showing a portion of the flange-receiving slots are aligned with notches formed in the gear ring when the gear ring of the gate controller in the first position;

FIG. 31 is view similar to FIG. 30 showing the gear ring of the gate controller has moved to the second position so that the notches in the gear ring have rotated about the cartridge axis;

FIG. 32 is diagrammatic perspective view of the dispenser being inserted into the cartridge mount included in the water treatment system of FIG. 15A showing the cartridge mount and the dispenser are in a sealed configuration in which the gate is in the closed position, the gear ring of the gate controller is in the first position, and the dispensing system is in the closed orientation to prevent any water treatment material from being dispensed in the storage reservoir;

FIG. 33 is a view similar to FIG. 32 showing the dispenser has been inserted into the cartridge mount so that the engagement flanges extend into the flange-receiving slots and the notches;

FIG. 34 is perspective view of the dispenser and the cartridge mount of FIG. 32 with a portion of the dispenser and the cartridge mount broken away to show as the dispenser is inserted into the cartridge mount, the rib is aligned with the guide slot of the lower valve;

FIG. 34A is a detail view of FIG. 34 showing locking pin of the upper valve is located in the guide slot so that the locking pin engages the lower valve and blocks rotation of the dispensing system;

FIG. 35 is a view similar to FIG. 34 showing the dispenser has been inserted into the cartridge mount with a downward axial force to cause the rib to deflect the spring arm of the upper valve partially out of the guide slot so that the dispenser is free to be rotated about the cartridge axis;

FIG. 35A is a detail view of FIG. 35 showing the locking pin of the upper valve is spaced apart from the guide slot so that the larger diameter portion of the locking pin is located out of the counterbore allowing rotation of the dispenser about the cartridge axis;

FIG. 36 is diagrammatic perspective view of the cartridge mount and the dispenser of the water treatment system of FIG. 15A showing the cartridge mount and the dispenser in the sealed configuration;

FIG. 37 is view similar to FIG. 36 showing the dispenser has been rotated to cause the cartridge mount and the dispenser to change to the unsealed configuration in which the gate is in the open position, the gear ring of the gate controller is in the second position, and the dispensing system is in the open orientation to allow the water treatment material to be dispensed into the storage reservoir;

FIG. 38 is a cross-section view of the cartridge mount and the dispenser of FIG. 36 taken along line 36-36 showing the gear ring of the gate controller is in the first position to cause the gate to be in the closed position so as to block the passageway and the dispensing system is in the closed orientation so that the upper valve covers the lower openings of the lower valve to block any water treatment material from flowing through the passageway;

FIG. 39 is a cross-section view of the cartridge mount and the dispenser of FIG. 37 taken along line 37-37 showing the gear ring of the gate controller is in the second position to cause the gate to be in the open position so as to open the passageway and the dispensing system is in the open orientation so that the upper openings of the upper valve are aligned with the lower openings of the lower valve to allow the water treatment material to flow through the passageway; and

FIG. 40 is an elevation view of the control system included in the water treatment of FIG. 15A showing the control system further includes a user interface that receives inputs from the user to control the mode of the system and is also configured to provide information and/or instructions to the user via sounds or lights.

### DETAILED DESCRIPTION OF THE DRAWINGS

For the purposes of promoting an understanding of the principles of the disclosure, reference will now be made to a number of illustrative embodiments illustrated in the drawings, and specific language will be used to describe the same.

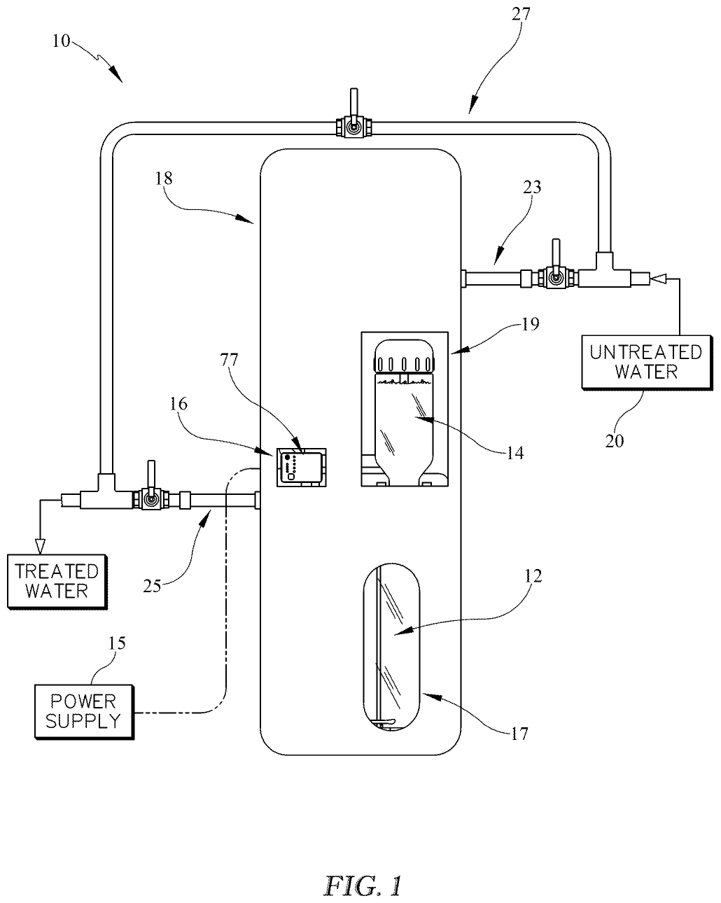

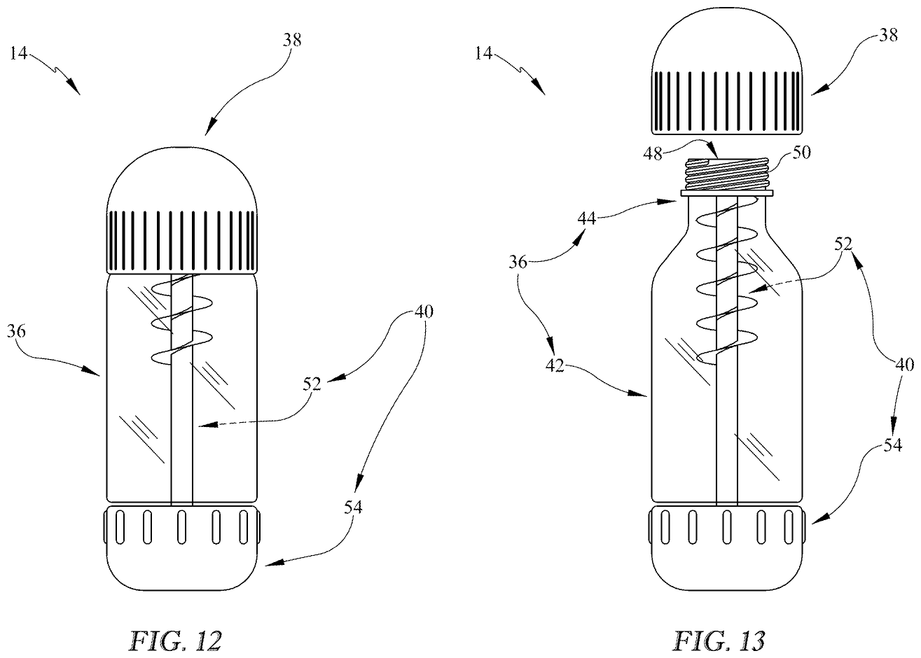

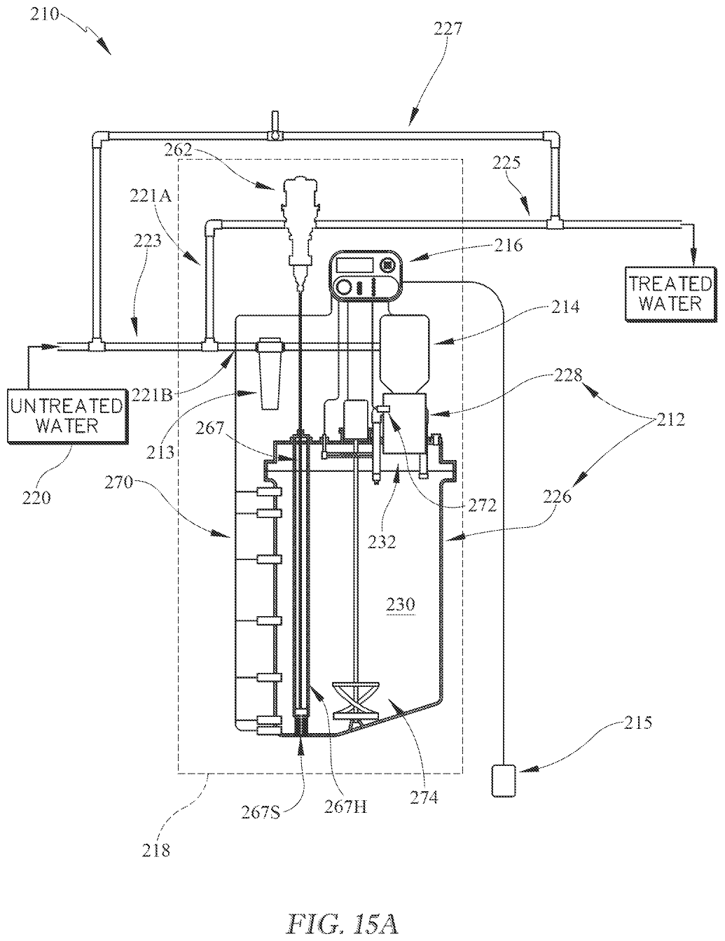

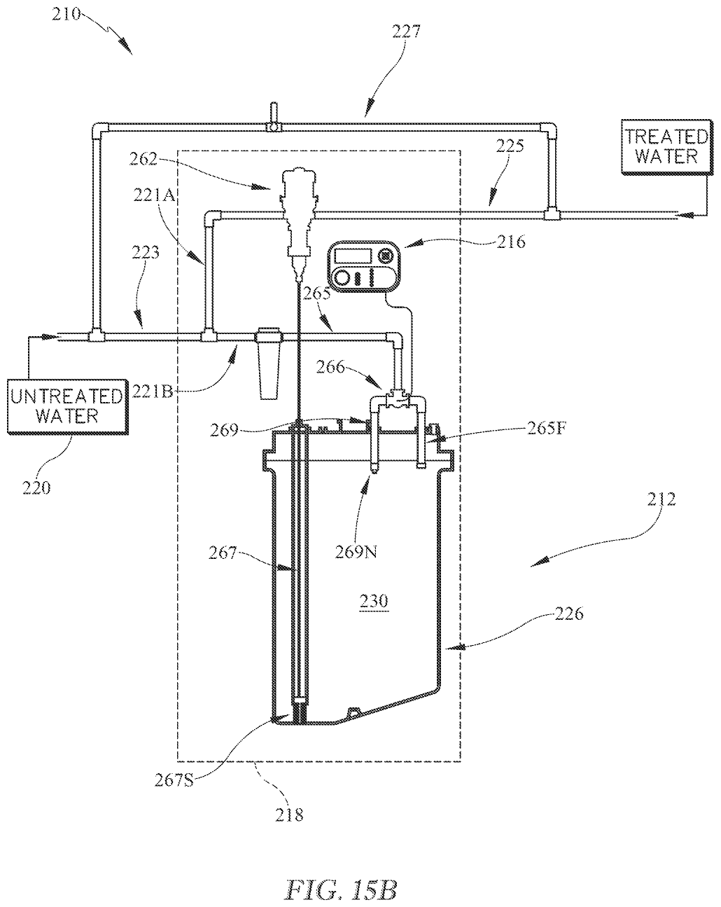

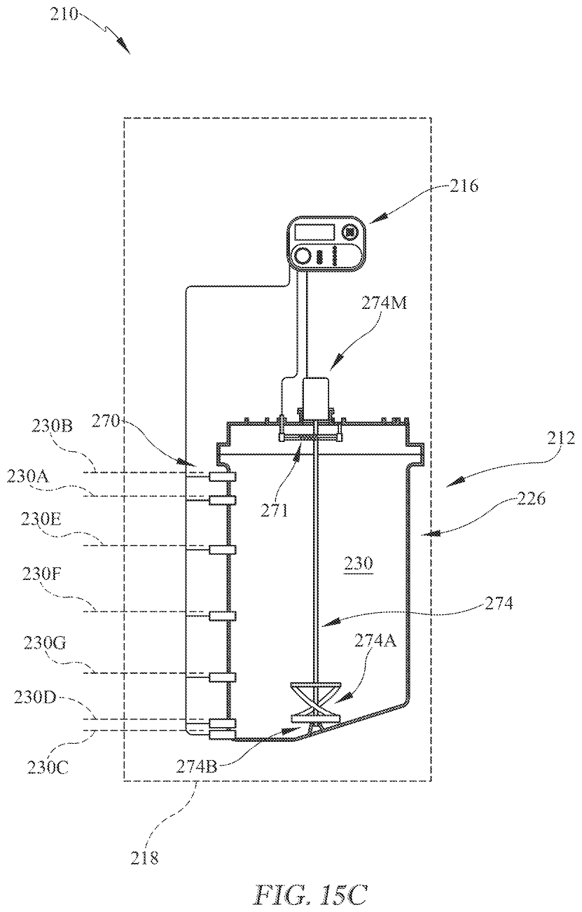

A first embodiment of an illustrative water treatment system 10 for treating a water supply 20 with a water treatment solution 22 is shown in FIGS. 1-9. The water treatment system 10 includes a tank 12 and a dispenser 14 configured to be coupled to the tank 12 as shown in FIGS. 1-14. A second embodiment of a water treatment system 210 is shown in FIGS. 15A-40.

The water treatment system 10 includes a tank 12, a dispenser 14, and a control system 16 as shown in FIGS. 1-13. The tank 12 is in fluid communication with the water supply 20 to receive a flow of water from the water supply 20. The dispenser 14 is configured to be coupled to the tank 12 and dispense a water treatment material 24, citric acid powder in the illustrative embodiment, at a predetermined flow rate into a storage reservoir 30 of the tank 12. The control system 16 is configured to produce the water treatment solution 22 in the storage reservoir 30 of the tank 12 by combining the water and the water treatment material 24. Once the water treatment solution 22 is produced, the control system 16 is configured to dose the water supply 20 with the water treatment solution 22 from the storage reservoir 30.

In typical water treatment systems, the water supply may be introduced to a container or cartridge containing the water treatment material, or citric acid. The water flows through the cartridge and contacts the water treatment material. As the water contacts the water treatment material, the water treatment material reacts with hard minerals in the water to reduce water hardness.

However, the reaction of the water treatment material with the hard minerals in the water may vary as the water flows through the cartridge thereby reducing the effectiveness of the water treatment material. For instance, the water treatment material may solidify or crystalize if the water treatment material stays stagnant for long periods of time, reducing its ability to dissolve and react with the water flowing through the system. As a result, the hardness of the water remains at high levels, and the solidified water treatment material needs to be replaced. Continually replacing the water treatment material may be expensive and wasteful.

To treat the water supply effectively and accurately, the present disclosure teaches the water treatment system 10 uses a doser 62 included in the system 10 to dose the water supply 20 with the water treatment solution 22. Unlike the other water treatment systems that introduce the water supply 20 to the water treatment material 24, the water treatment system 10 stores a water treatment solution 22 to be dosed into the water supply 20 as needed.

The tank 12 included in the system 10 stores the water treatment solution 22 and while the doser 62 doses a predetermined amount of the water treatment solution 22 into the water supply 20 so that the water treatment solution 22 reacts effectively with hard minerals. In this way, the hardness of the water supply 20 is better reduced compared to other water treatment systems.

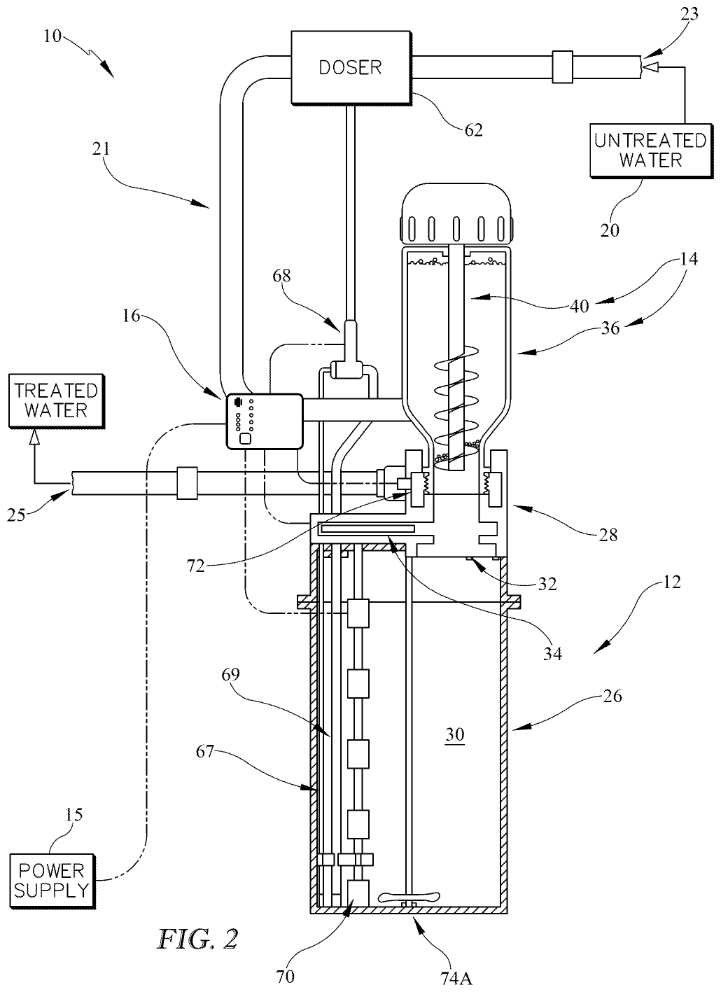

For holding the water treatment solution 22, the tank 12 includes a tank housing 26 and a cartridge mount 28 as shown in FIGS. 2 and 4-9. The tank housing 26 is formed to define the storage reservoir 30. The cartridge mount 28 is coupled the tank housing 26 and formed to include a tank opening 32 arranged to open into the storage reservoir 30.

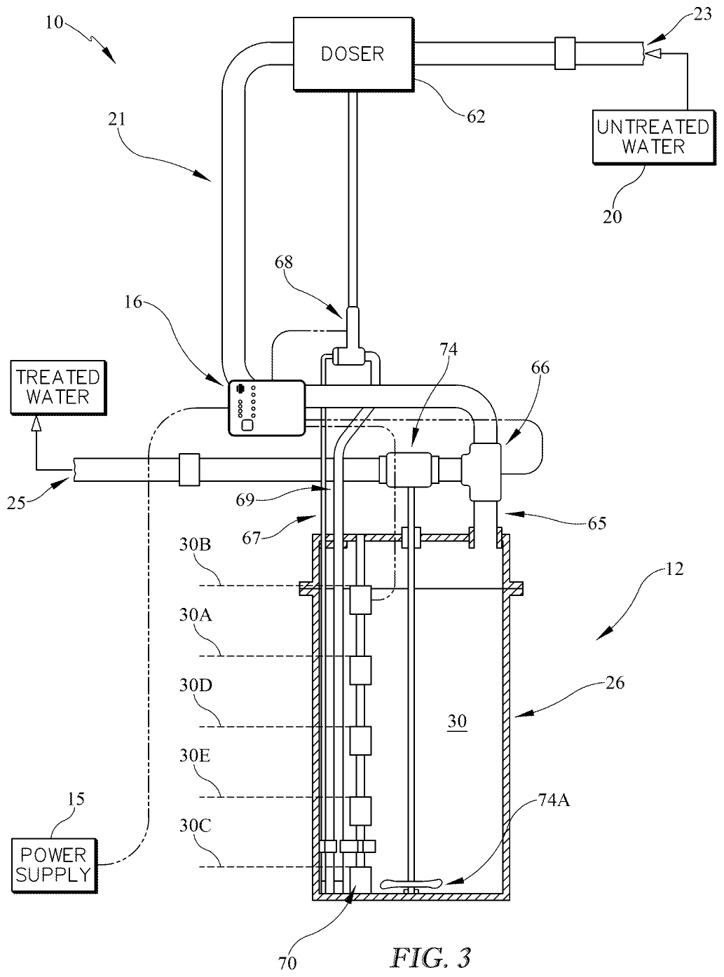

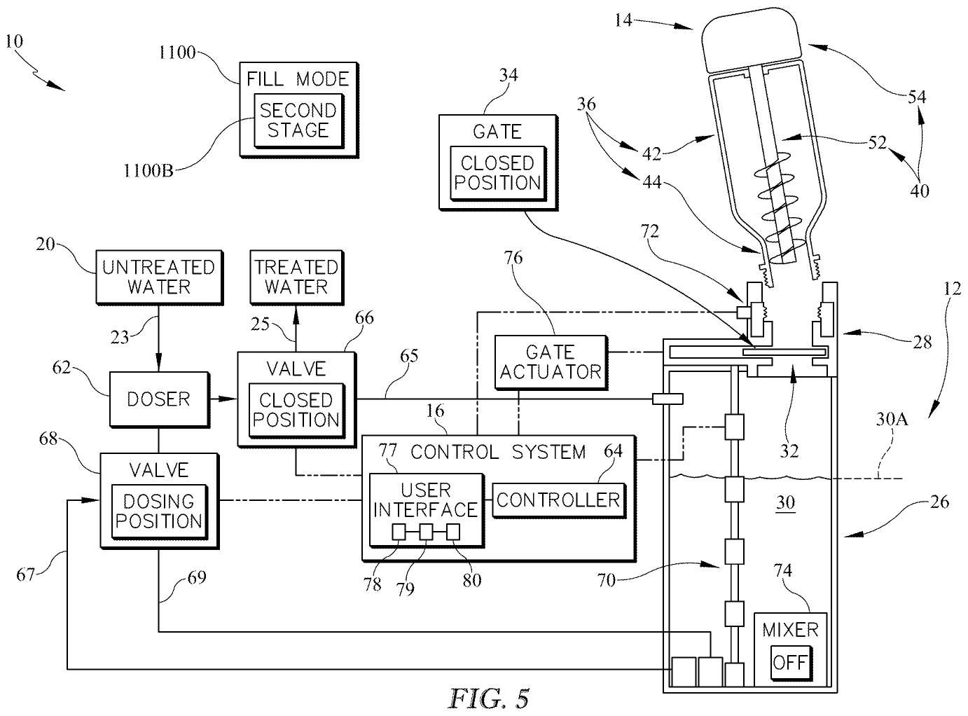

The cartridge mount 28 includes a gate 34 as shown in FIGS. 2 and 4-9. The gate 34 is configured to change between a closed position as shown in FIG. 5 and an open position as shown in FIGS. 3-4 and 6-9. In the closed position, the gate 34 closes the tank opening 32 and blocks access to the storage reservoir 30 through the tank opening 32. In the open position, the gate 34 has moved away from the tank opening 32 to allow access to the storage reservoir 30 through the tank opening 32.

To add the water treatment material 24 to the water in the storage reservoir 30, the dispenser 14 is configured to dispense the material 24 at the predetermined flow rate into the water contained in the storage reservoir 30. The dispensing of the water treatment material 24 may be important to effectively producing the water treatment solution 22. If the water treatment material 24 is added too quickly, the water treatment material 24 may conglomerate, not mixing properly with the water and forming deposits of crystalized material. The dispenser 14 dispenses the water treatment material 24 at the predetermined flow rate so that the water treatment material 24 will effectively dissolve in the water in the storage reservoir 30.

The dispenser 14 includes a cartridge 36, a cap 38, and a dispensing system 40 as shown in FIGS. 2 and 4-13. The cartridge 36 is shaped to define an interior storage region 46 that is configured to store the water treatment material 24. The cap 38 is configured to be coupled to the cartridge 36 to block any water treatment material 24 from exiting the cartridge 36. The dispensing system 40 is configured to control the dispensing of the water treatment material 24 out of the cartridge 36 at the predetermined flow rate.

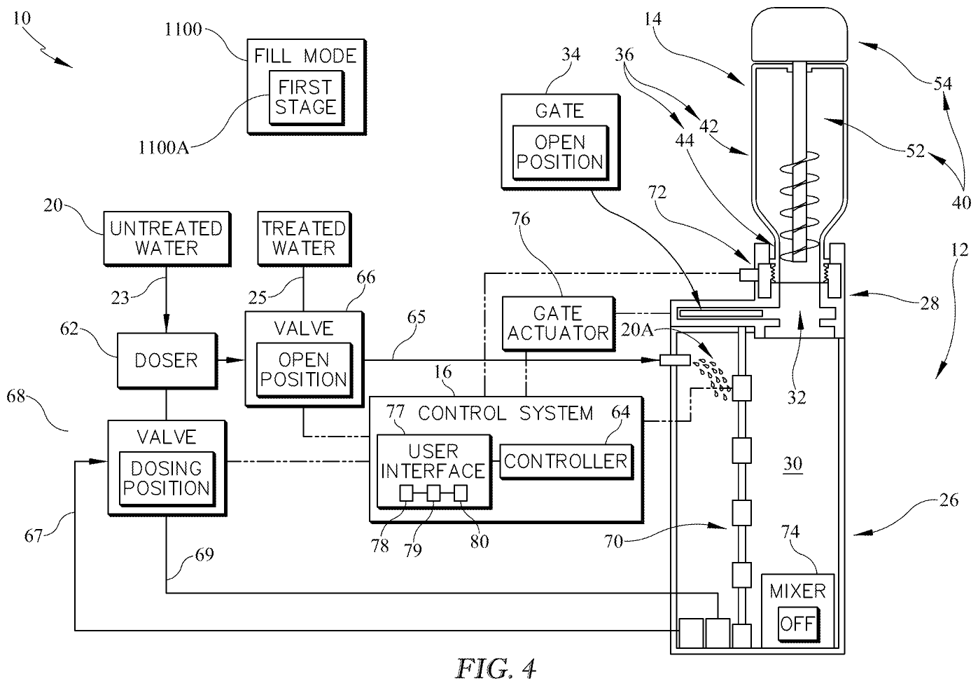

The cartridge 36 includes a body 42 and a neck 44 as shown in FIGS. 4-11 and 13. The body 42 is formed to include the interior storage region 46 that stores the water treatment material 24. The neck 44 is coupled to the body 42 and formed to include an opening 48 arranged to open into the interior storage region 46.

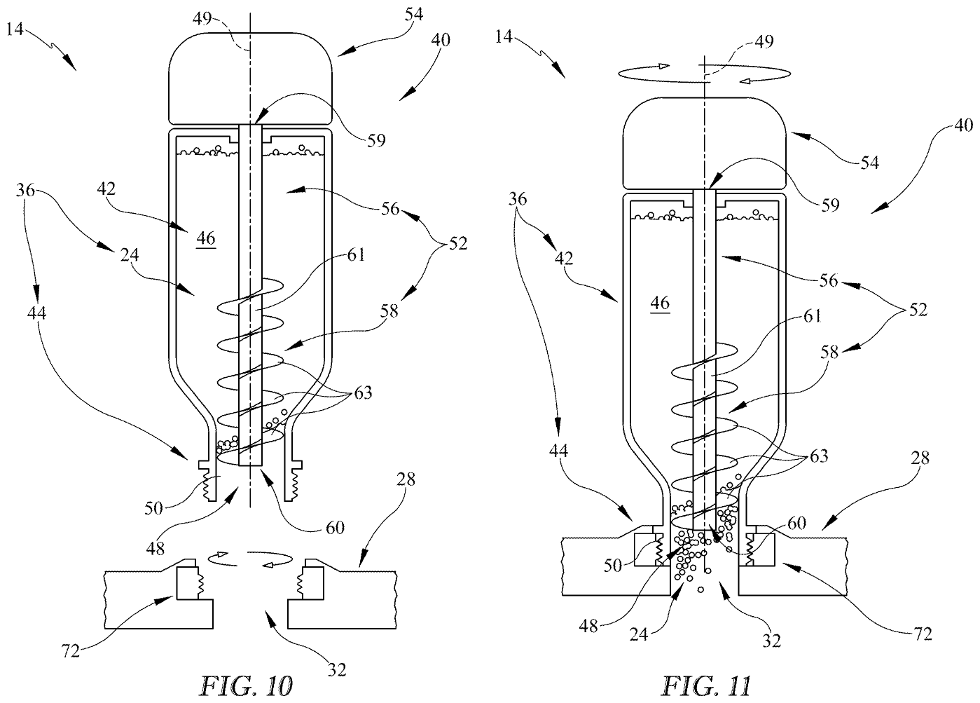

In the illustrative embodiment, the neck 44 is configured to couple to the cartridge mount 28 of the tank 12 as suggested in FIGS. 10 and 11. The neck 44 is shaped to include threads 50 that mate with the cartridge mount 28 to couple the cartridge 36 to the cartridge mount 28. In this way, the water treatment material 24 dispensed from the cartridge 36 is added to the water in the storage reservoir 30 of the tank 12 to produce the water treatment solution 22.

The dispensing system 40 is configured to control the dispensing of the water treatment material 24 through the opening 48 in the neck 44 of the cartridge 36 at the predetermined flow rate. The dispensing system 40 controls the dispensing of the water treatment material 24 so that the addition of the water treatment material 24 to the water in the storage reservoir 30 is controlled over a predetermined time period. In this way, the water may not be over saturated with the water treatment material 24 too quickly. If the water treatment material 24 is added too quickly, the water treatment material 24 may conglomerate and form clumps in the solution, influencing the effectiveness of the solution 22 in treating the water supply 20.

In the illustrative embodiment, the dispensing system 40 includes an auger 52 and a knob 54 as shown in FIGS. 4-11. The auger 52 extends through the body 42 of the cartridge 36 into the interior storage region 46 and is configured to rotate about an axis 49 of the dispensing system 40. The auger 52 blocks off the opening 48 of the cartridge 36 to prevent the water treatment material 24 from directly moving through the opening 48. The knob 54 is coupled to a first end 59 of the auger 52 located outside the interior storage region 46.

The knob 54 is configured to be rotated by a user to cause the auger 52 to rotate about the axis 49. In this way, the auger 52 gathers predetermined amounts of the water treatment material 24 and transports the predetermined amounts of the water treatment material 24 through the opening 48 to dispense the water treatment material 24 at the predetermined flow rate in the storage reservoir 30.

The auger 52 includes a shaft 56 and a helical screw 58 as shown in FIGS. 10 and 11. The shaft 56 is shaped to include the first end 59, a second end 60 spaced apart axially from the first end 59 to define a length of the shaft, and an outer surface 61. The outer surface 61 extends between and interconnects the first end 59 and the second end 60. The helical screw 58 is coupled to the outer surface 61 of the shaft 56.

The helical screw 58 extends radially outward from and circumferentially around the outer surface 61 of the shaft 56 along at least part of the length of the shaft 56 as shown in FIGS. 10 and 11. The helical screw 58 has a portion that is located in the opening 48 of the neck 44 to block the water treatment material 24 from moving out of the interior storage region 46.

In the illustrative embodiment, the helical screw 58 extends along at least half the length of the shaft 56. In other embodiments, the helical screw 58 may extend more than or less than half the length of the shaft 56.

The helical screw 58 is shaped to define fins 63 as shown in FIGS. 10 and 11. The fins 63 are spaced apart axially from each other relative to the axis. At least one of the fins 63 abuts an inner surface of the neck 44 in the opening 48 to block the water treatment material 24 from moving out of the interior storage region 46.

As the knob 54 is rotated by the user, the auger 52 is rotated causing the fins 63 of the helical screw 58 to move in the opening 48 and carry water treatment material 24 from the region 46 and move it across the opening 48. The spacing of the fins 63 along the axis 49 determines the predetermined amount of the water treatment material 24 dispensed with each rotation of the knob 54.

The control system 16 comprises the doser 62 in fluid communication with the storage reservoir 30 and the water supply 20 and a controller 64 coupled to the doser 62 as shown in FIGS. 2-14. The doser 62 is configured to dose the water supply 20 with the water treatment solution 22. The controller 64 is configured to direct the doser 62 to dose a predetermined amount of the water treatment solution 22 into the water supply 20 so that the water treatment solution 22 reacts with the hard minerals in the water supply 20 thereby reducing water hardness.

The doser 62 is configured to dose the predetermined amounts of water treatment solution 22 into the water supply 20 at varying flow rates based on a water flow rate through the doser 62. The doser 62 is configured to dose the predetermined amount of water treatment solution 22 at a first flow rate if the doser 62 determines the water is flowing through the doser 62 at a first water flow rate. If the water flow rate increases to a second water flow rate that is greater than the first water flow rate, the doser 62 is configured to proportionately increase the flow rate of dosing to a second flow rate. Conversely, if the water flow rate decreases to a third water flow rate that is less than the first and second water flow rates, the doser 62 is configured to proportionately decrease the flow rate of dosing to a third flow rate.

In this way, accurate and proportional amounts of the water treatment solution 22 may be added water supply 20 compared to other methods that introduce the water to the water treatment material 24. Injecting the water treatment solution 22 into the water flowing through the doser 62 based on the water flow rate may prevent the water supply 20 from becoming over or under saturated with the water treatment solution 22. In other embodiments, the doser 62 may be configured to determine a pH level of the water and vary the injection of the predetermined amount of water treatment solution 22 based on the measured pH level.

The control system 16 further includes a plurality of valves 66, 68, sensors 70, 72, a mixer 74, and a gate actuator 76 as shown in FIGS. 2-9. The valves 66, 68 control the flows into the storage reservoir 30 and to the doser 62. The sensors 70, 72 are configured to detect aspects of the system 10 and provide feedback to the controller 64. The mixer 74 is located in the storage reservoir 30. The mixer 74 is configured to mix the water treatment solution 22 in the storage reservoir 30 to prevent the water treatment solution 20 from settling in the storage reservoir 30. The gate actuator 76 is coupled the gate 34 and configured to cause the gate 34 to move between the closed position and the open position.

The plurality of valves includes a first valve 66 in fluid communication with the water supply 20 and the storage reservoir 30 and a second valve 68 in fluid communication with the storage reservoir 30 and the doser 62 as shown in FIGS. 2-9. The first valve 66 is configured to vary the flow of water from the water supply 20 into the tank 12. The second valve 68 controls the fluid connection of the doser 62 to the storage reservoir 30.

In the illustrative embodiment, the first valve 66 is in fluid communication with a tank inlet conduit 65 as shown in FIGS. 2-9. The tank inlet conduit 65 in fluid communication between the first valve 66 and the storage reservoir 30. The first valve 66 is configured to vary the flow of water from the water supply 20 through the tank inlet conduit 65 to the storage reservoir 30.

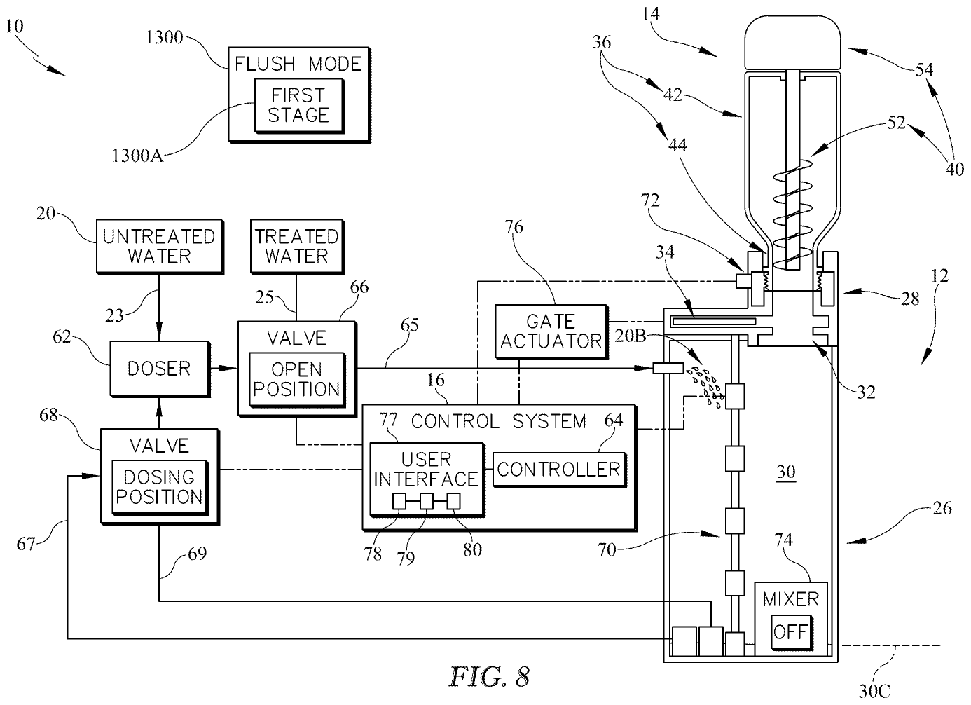

The controller 64 is configured to change the first valve 66 between an open position as shown in FIGS. 4 and 8 and a closed position as shown in FIGS. 5-7 and 9. In the open position, the first valve 66 allows the flow of water from the water supply 20 through the tank inlet conduit 65 into the storage reservoir 30. In the closed position, the first valve 66 blocks the flow of water from the water supply 20 through the tank inlet conduit 65 into the storage reservoir 30.

In the illustrative embodiment, the second valve 68 in fluid communication between the doser 62 and dosing and flushing conduits 67, 69 as shown in FIGS. 2-9. The dosing conduit 67 and the flushing conduit 69 are both in fluid communication between the second valve 68 and the storage reservoir 30. A clip (not shown) may be extend between the tank housing 26 and the conduits 67, 69 to couple the conduits 67, 69 in place on the tank housing 26 in some embodiments.

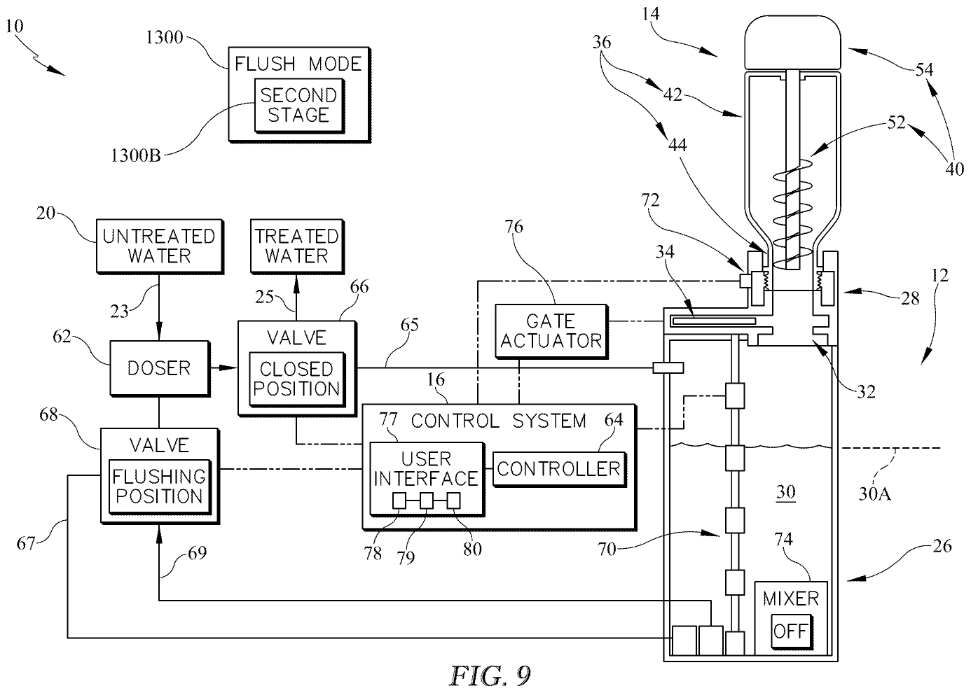

The second valve 68 is configured to change between a dosing position as shown in FIGS. 4-8 and a flushing position as shown in FIG. 9. In the dosing position, the second valve 68 allows a flow of the water treatment solution 22 from the storage reservoir 30 to the doser 62 and blocks flow through the flushing conduit 69. In the flushing position, the second valve 68 allows flow through the flushing conduit 69 and blocks flow through the dosing conduit 67.

The sensors 70, 72 include a level sensor 70 and a cartridge sensor 72 as shown in FIGS. 2-11. The level sensor 70 is located in the storage reservoir 30 and coupled to the controller 64. The level sensor 70 is configured to measure a fill level 30A-30E of the water treatment solution 22 in the storage reservoir 30. The cartridge sensor 72 is coupled to the cartridge mount 28 of the tank 12. The cartridge sensor 72 is configured to detect if the dispenser 14 is coupled to the cartridge mount 28.

The controller 64 is configured to direct the valves 66, 68 to change between their corresponding positions based on the feedback from the fill sensor 70. The controller 64 is configured to direct the first valve 66 to change between the open and closed positions to vary the flow of water into the storage reservoir 30 based on the fill level 30A-30E measured by the fill sensor 70. The controller 64 is configured to direct the second valve 68 to vary the flow path of the liquid between the dosing conduit 67 and the flushing conduit 69 to the doser 62 based on the fill level 30A-30E measured by the level sensor 70.

The controller 64 is coupled to the gate actuator 76 and the cartridge sensor 72. The controller 64 is configured to direct the gate actuator 76 to move the gate 34 to the open position if the cartridge sensor 72 detects the dispenser 14 is coupled to the cartridge mount 28 of the tank 12. Conversely, if the cartridge sensor 72 does not detect that the dispenser 14 is coupled to the cartridge mount 28, the controller 64 is configured to direct the gate actuator 76 to move the gate 34 to the closed position so as to block access through the tank opening 32. This prevents any of the material and/or liquid inside from contacting the user during refiling.

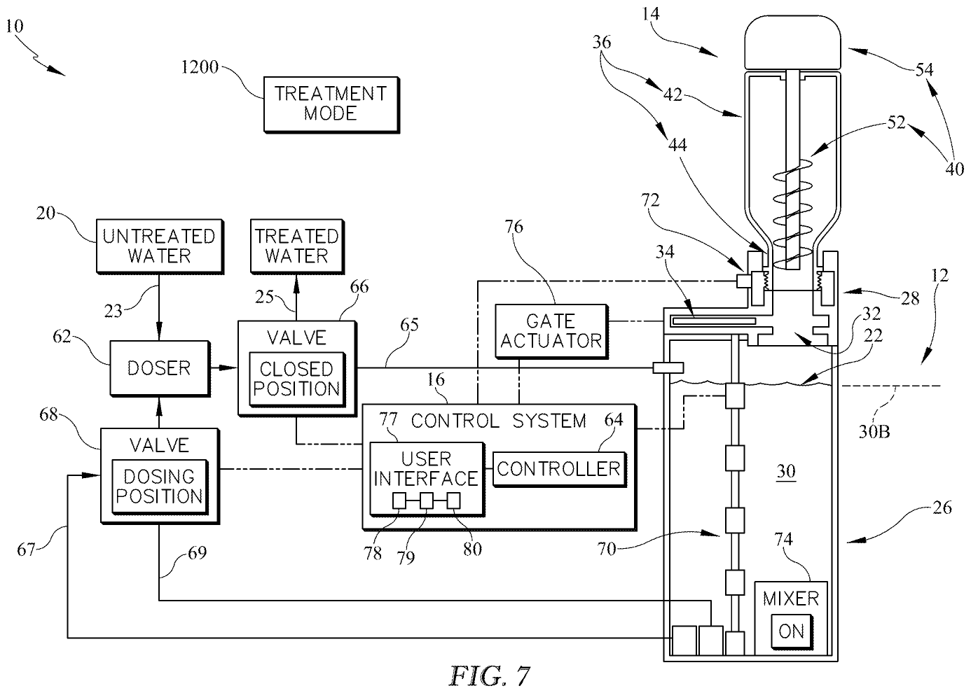

The system 10 is configured to operate in three different modes: a fill mode 1100 as shown in FIGS. 4-6, a treatment mode 1200 as shown in FIG. 7, and a flush mode 1300 as shown in FIGS. 8 and 9. The fill mode 1100 is when the reservoir of the water treatment solution 22 in the tank 12 needs to be replenished. The treatment mode 1200 is when the water treatment solution 22 is dosed into the water supply 20. The flush mode 1300 is after the reservoir of the water treatment solution 22 is depleted and before the fill mode 1100 so as to flush out any remaining fluid in the storage reservoir 30 and clean the tank 12. The stages 1100, 1200, 1300 are repeated to refill whenever the water treatment solution reservoir becomes depleted.

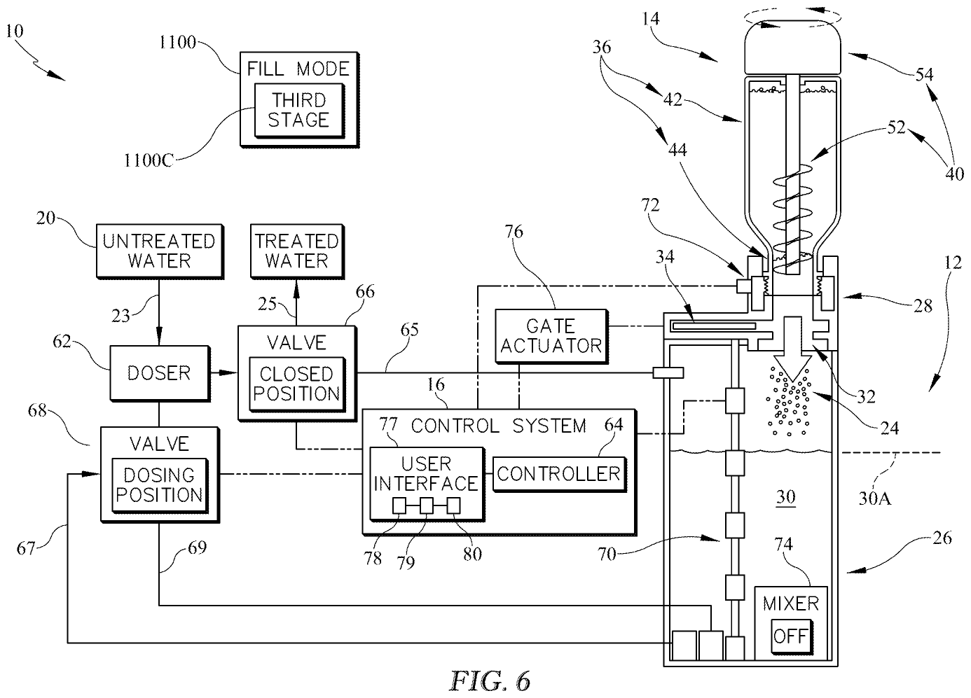

The fill mode 1100 includes three stages: a first stage 1100A as shown in FIG. 4, a second stage 1100B as shown in FIG. 5, and a third stage 11000 as shown in FIG. 6. In first stage 1100A of the fill mode 1100, the storage reservoir 30 is empty and the controller 64 directs the first valve 66 to change to the open position to allow a first flow of water 20A from the water supply 20 into the tank 12. The first valve 66 remains in the open position until the fill sensor 70 detects a first predetermined fill level 30A in the storage reservoir 30. Once the fill sensor 70 detects the first predetermined fill level 30A in the storage reservoir 30, the controller 64 directs the first valve 66 to change to the closed position.

The first predetermined fill level 30A corresponds to the storage reservoir 30 being at about 75% of its maximum volume. In the illustrative embodiment, the first predetermined fill level 30A is about 1.3 gallons or about 74% of a volume of the storage reservoir 30.

In the second stage 1100B of the fill mode 1100, the user is directed to replace the old empty dispenser 14 with a new full dispenser 14 containing the water treatment material 24, or citric acid powder to be added through the tank opening 32. To do so, the user removes the old empty dispenser 14 from the cartridge mount 28, which causes the cartridge sensor 72 to detect the dispenser 14 is no longer coupled to the cartridge mount 28. In response, the controller 64 directs the gate actuator 76 to move the gate 34 to the closed position.

The user then couples the new full dispenser 14 to the cartridge mount 28 for dispensing, which causes the cartridge sensor 72 to detect the dispenser 14 is coupled to the cartridge mount 28. In response, the controller 64 directs the gate actuator 76 to move the gate 34 to the open position so that the water treatment material 24 is ready to be dispensed.

In the third stage 11000 of the fill mode 1100, the user is directed to the add the water treatment material 24 to the storage reservoir 30 by rotating the knob 54 as shown in FIG. 6. The rotation of the knob 54 causes the auger 52 to rotate and dispense the predetermined amounts into the storage reservoir 30 at the predetermined flow rate. The user continues to dispense the water treatment solution 24 into the reservoir 30 until the fill sensor 70 detects a second predetermined fill level 30B in the storage reservoir 30. In the illustrative embodiment, the dispenser 14 should be empty or close to empty when the fill sensor 70 detects a second predetermined fill level 30B in the storage reservoir 30.

Once the fill sensor 70 detects the second predetermined fill level 30B in the storage reservoir 30, the controller 64 indicates the system 10 is now in the treatment mode 11001B. The user is then directed to stop rotating the knob 54 of the dispensing system 40, and the controller 64 directs the system 10 to begin the treatment mode 1200.

In the treatment mode 1200, the controller 64 directs the mixer 74 to change form an off mode as shown in FIGS. 4-6 and 8-9 to an on mode as shown in FIG. 7. In the on mode, the mixer 74 is directed to mix the water and the water treatment material 24 together to completely dissolve the water treatment material 24 in the water and produce the water treatment solution 22. The controller 64 then directs the doser 62 to dose the predetermined amount of the water treatment solution 22 into the water supply 20.

The controller 64 directs the doser 62 to dose the predetermined amount of the water treatment solution 22 at a predetermined flow rate based on the water flow rate through the conduit 21. The doser 62 is configured to detect the water flow rate and to dose the predetermined amount of water treatment solution 22 a proportional flow rate based on the water flow rate. The doser 62 is configured to vary the dosing flow rate depending on changes of the water flow rate.

When the fill sensor 70 detects a third predetermined fill level 30C in the storage reservoir 30 that corresponds to the reservoir 30 being depleted or empty, the treatment mode 1200 is ended. The controller 64 then begins the flush mode 1300 as shown in FIG. 8.

The flush mode 1300 includes two stages: a first stage 1300A and a second stage 1300B as shown in FIGS. 8 and 9. In the first stage 1300A of the flush mode 1300, as shown in FIG. 8, the controller 64 directs the first valve 66 to change to the open position to conduct a second flow of water 20B into the reservoir 30 to flush out the tank 12 after the third predetermined fill level is detected by the fill sensor 70.

The first valve 66 remains in the open position until the fill sensor 70 detects the first predetermined fill level 30A. Once the fill sensor 70 detects the first predetermined fill level 30A, the controller 64 directs the first valve 66 to change to the closed position, which triggers the second stage 1300B of the flush mode 1300.

In the second stage 1300B of the flush mode 1300B, as shown in FIG. 9, the controller 64 directs the second valve 68 to change to the flushing position to allow flow through the flushing conduit 69 to the doser 62. The controller 64 simultaneously directs the doser 62 to continuously dose the fluid in the reservoir 30 into the water supply 20. The doser 62 doses the fluid in the reservoir 30 into the water supply 20 so as to empty the reservoir 30 for refiling with the water treatment solution 22.

The second stage 1300B ends when the fill level sensor 70 detects the third predetermined fill level 30C. Once the third predetermined fill level 30C is detected, the controller 64 directs the second valve 68 to move to the dosing position and the user is signaled to begin the fill mode 1100.

In the illustrative embodiment, the control system 16 includes a user interface 77 as shown in FIGS. 1, 4-9, and 14. The user interface 77 is coupled to the controller 64 and is configured to receive inputs from the user. The user interface 77 indicates to the user when the system 10 is in each of the different modes 1100, 1200, 1300 and provides the user with instructions via sounds, lights, digital display, or other similar means of communication to indicate action is needed.

The user interface 77 includes an input system 78, an output system 79 coupled to the input system 78, and a communication unit 80 coupled to the input and output systems 78, 79 as shown in FIGS. 4-9 and 14. The input system 78 and the output system 79 are both coupled to the controller 64 to receive and send information to the controller 64. The communication unit 80 is coupled to the controller 64 and the input and output systems 78, 79 and is configured to receive and send information to a wireless device, such as a smart phone, a tablet, computer, or another suitable device.

The input system 78 is configured to provide the input from the user through a button, a sensor, combination thereof, or any suitable alternative. In the illustrative embodiment, the input system is a fill button 78B, which directs the controller 64 to begin the fill mode 1100 when the user presses the fill button 78. In other embodiments, the input system 78 may be an app for a smart device in which the user is able to control the system 10.

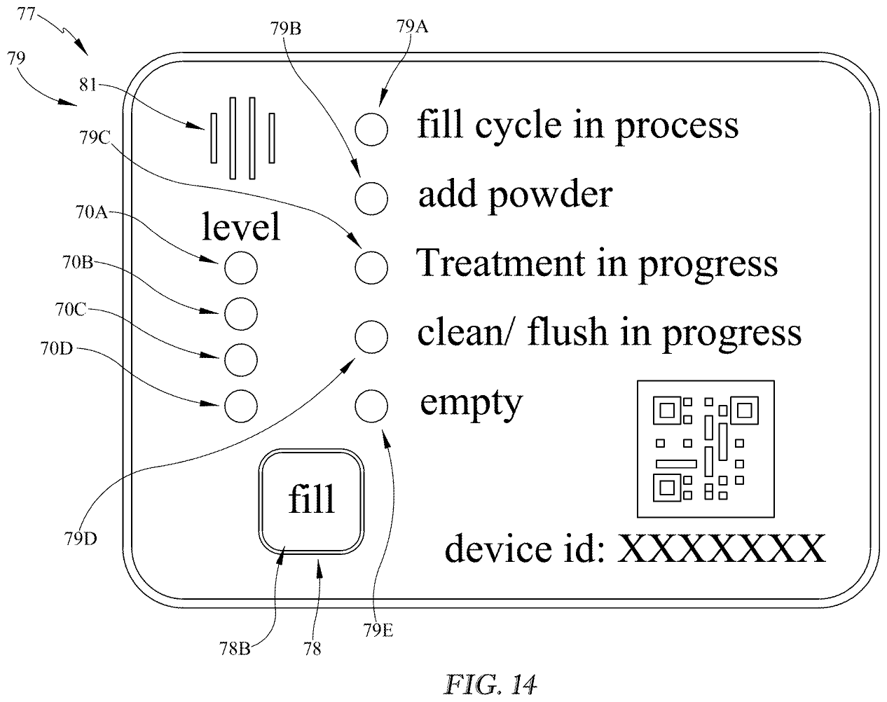

The output system 79 is configured to provide instructions or information to the user. The output system includes a set of fill level visual indicators 70A, 70B, 70C, 70D, a set of status visual indicators 79A, 79B, 79C, 79D, 79E, and a speaker 81 as shown in FIG. 14. The visual indicators 70A, 70B, 70C, 70D, 79A, 79B, 79D, 79E are LED lights in the illustrative embodiment.

The fill level visual indicators 70A, 70B, 70C, 70D are coupled with the fill level sensor 70 and configured to receive a signal from the sensor 70 corresponding to the fill level 30A-30E of the storage reservoir 30. Based on the fill level 30A-30E of the reservoir 30, the visual indicators 70A, 70B, 70C, 70D emit a light to indicate the fill level 30A-30E of the reservoir 30.

In the illustrative embodiment, the fill level visual indicators 70A, 70B, 70C, 70D include a first fill-level indicator 70A, a second fill-level indicator 70B, a third fill-level indicator 70C, and a fourth fill-level indicator 70D as shown in FIG. 14. The first fill-level indicator 70A indicates when the storage reservoir 30 is filled to the maximum volume of the reservoir 30 with the water treatment solution 22. The second fill-level indicator 70B indicates when the storage reservoir 30 contains about 75% of the maximum volume of the reservoir 30. The third fill-level indicator 70C indicates when the storage reservoir 30 contains about 50% of the maximum volume of the reservoir 30. The fourth fill-level indicator 70D indicates when the storage reservoir 30 contains about 25% of the maximum volume of the reservoir 30.

The controller 64 is configured to direct the first fill-level indicator 70A to turn on when the fill level sensor 70 detects the second predetermined fill level 30B, i.e. 100% of the maximum volume of the storage reservoir 30. The controller 64 is configured to direct the first fill-level indicator 70A to turn off and the second fill-level indicator 70B to turn on when the fill level sensor 70 detects the first predetermined fill level 30A, i.e. 75% of the maximum volume of the storage reservoir 30. The controller 64 is configured to direct the second fill-level indicator 70B to turn off and the third fill-level indicator 70C to turn on when the fill level sensor 70 detects a fourth predetermined fill level 30D, i.e. 50% of the maximum volume of the storage reservoir 30. The controller 64 is configured to direct the third fill-level indicator 70C to turn off and the fourth fill-level indicator 70D to turn on when the fill level sensor 70 detects a fifth predetermined fill level 30E, i.e. 25% of the maximum volume of the storage reservoir 30.

When the controller 64 directs one of the fill level indicators 70A, 70B, 70C, 70D to turn on, the corresponding indicator 70A, 70B, 70C, 70D is configured to emit a light to the user. In some embodiments, the indicator 70A, 70B, 70C, 70D may emit a constant light. In other embodiments, the indicator 70A, 70B, 70C, 70D may emit a blinking light.

In some embodiments, the fill level indicators 70A, 70B, 70C, 70D may emit lights having the same color. In other embodiments, the fill level indicators 70A, 70B, 70C, 70D may emit lights that have different colors or some of the indicators 70A, 70B, 70C, 70D may be the same color while some of the others are different colors.

The status visual indicators 79A, 79B, 79C, 79D, 79E are coupled to the controller 64 and configured to indicate the stage of the system 10. The status visual indicators include a fill mode indicator 79A, an add powder indicator 79B, a treatment mode indicator 79C, a flush mode indicator 79D, and an empty indicator 79E as shown in FIG. 14. The each of the indicators 79A, 79B, 79C, 79D, 79E is directed by the controller 64 to emit a light to indicate to the user the mode of the system 10.

In the illustrative embodiment, the controller 64 directs each of the indicators 79A, 79B, 79C, 79D, 79E to emit a blinking light when turned on. In other embodiments, each of the indicators 79A, 79B, 79C, 79D, 79E is configured to emit a continuous light when directed to turn on by the controller 64.

In some embodiments, the indicators 79A, 79B, 79C, 79D, 79E may emit lights having the same color. In other embodiments, the indicators 79A, 79B, 79C, 79D, 79E may emit lights that have different colors or some of the indicators 79A, 79B, 79C, 79D, 79E may be the same color while some of the others are different colors.

The fill mode indicator 79A is configured to emit a light when the system 10 is in the fill mode 1100. After the user presses the fill button 78B, the controller 64 directs the fill mode indicator 79A to turn on, while the other indicators 79B, 79C, 79D, 79E are directed to remain off. As the system 10 enters the third stage 11000 of the fill mode 1100, the controller 64 directs the add powder indicator 79B to turn on along with the fill mode indicator 79A.

Once the fill mode 1100 is completed, the controller 64 directs the fill mode indicator 79A and the add powder indicator 79B to turn off and directs the treatment mode indicator 79C to turn on. The treatment mode indicator 79B remains on, until the fill sensor 70 detects the third predetermined fill level 30C and the flush mode 1300 is started.

Once the flush mode 1300 is started, the controller 64 directs the treatment mode indicator 79C to turn off and directs the flush mode indicator 79D to turn on. The flush mode 1300 is completed such that the third predetermined fill level 30C is again detected by the sensor 70. The detection of the third predetermined fill level 30C by the sensor 70 after the flush mode 1300 signals to the controller 64 to direct the flush mode indicator 79D to turn off and to direct the empty indicator 79E to turn on. Simultaneously, the controller 64 may direct the speaker 81 to emit an alarm or noise to signal to the user that the storage reservoir 30 is empty and that the fill mode 1100 needs to be initiated.

The communication unit 80 is coupled to the controller 64 and the input and output systems 78, 79 and is configured to use wireless signals to communicate with the user's smart phone, tablet, computer, or another suitable device. The wireless signals may BLUETOOTH®, Wi-Fi, or any other suitable alternative.

After the fill mode 1100 is completed and the fill level sensor 70 detects the second predetermined fill level 30B, the controller 64 is configured to direct the communication unit 80 to send a signal via Wi-Fi to the user's wireless device. The signal indicates, via a phone app or SMS notification, that the storage reservoir 30 is at a 100% fill level and that the treatment mode 1200 is in progress.

During the treatment mode 1200, as the water treatment solution 22 in the reservoir 30 depletes, the controller 64 is configured to direct the communication unit 80 to send signals via Wi-Fi to the user's wireless device indicating the new fill level in the reservoir 30.

The controller 64 is configured to direct the communication unit 80 to send a first signal via Wi-Fi to the user's wireless device indicating that the storage reservoir 30 is at 100% of the maximum volume of the storage reservoir 30 when the fill level sensor 70 detects the second predetermined fill level. Simultaneously, the first fill-level indicator 70A is configured to turn on.

The controller 64 is configured to direct the communication unit 80 to send a second signal via Wi-Fi to the user's wireless device indicating that the storage reservoir 30 is at 75% of the maximum volume of the storage reservoir 30 when the fill level sensor 70 detects the first predetermined fill level 30A. Simultaneously, the first fill-level indicator 70A turns off and the second fill-level indicator 70B is configured to turn on.

The controller 64 is configured to direct the communication unit 80 to send a third signal via Wi-Fi to the user's wireless device indicating that the storage reservoir 30 is at 50% of the maximum volume of the storage reservoir 30 when the fill level sensor 70 detects the fourth predetermined fill level 30D. Simultaneously, the second fill-level indicator 70B turns off and the third fill-level indicator 70C is configured to turn on.

The controller 64 is configured to direct the communication unit 80 to send a fourth signal via Wi-Fi to the user's wireless device indicating that the storage reservoir 30 is at 25% of the maximum volume of the storage reservoir 30 when the fill level sensor 70 detects the fifth predetermined fill level 30E. Simultaneously, the third fill-level indicator 70C turns off and the fourth fill-level indicator 70D is configured to turn on.

The controller 64 is configured to direct the communication unit 80 to send a fifth signal via Wi-Fi to the user's wireless device indicating that the storage reservoir 30 is at 0% of the maximum volume of the storage reservoir 30 or empty when the fill level sensor 70 detects the third predetermined fill level 30C. The fifth signal also indicates that the flush mode 1300 is in progress and a new dispenser 14 is needed. In some embodiments, the controller 64 is configured to send the fifth signal to the company to indicate a new dispenser 14 should be sent to the user. Once the user is ready to begin the fill mode 1100, the steps are repeated to create more water treatment solution 22 in the storage reservoir 30.

In the illustrative embodiment, the tank 12, the dispenser 14, and the control system 16 are contained inside a system housing 18 included in the water treatment system 10. The system housing 18 mounts the user interface 77 of the control system 16 so that the user may easily access the user interface 77. The system housing 18 is also configured to limit the user's access to the tank 12.

The system housing 18 surrounds the tank 12, the dispenser 14, and the control system 16 as shown in FIG. 1. The housing 18 is shaped to define a tank window 17 and a cartridge access port 19 as shown in FIG. 1. The tank window 17 is a transparent window to show the fill level of the tank 12. The cartridge access port 19 is configured to grant access to the cartridge mount 28 of the tank 12 so that the dispenser 14 may be selectively coupled to the cartridge mount 28.

The water supply 20 is coupled to an inlet 23 and an outlet 25 of a conduit 21 included in the system housing 18. The doser 62 is coupled to conduit 21 downstream of the inlet 23. The water supply 20 flows through the inlet 23 of the conduit 21 through the doser 62 before flowing through the first valve 66. When in the closed position, the valve 66 directs the flow of water to the outlet 25 of the system 10.

In the illustrative embodiment, the mixer 74 is a hydraulic mixer that includes a stirrer 74A which extends into the storage reservoir 30 as shown in FIGS. 2 and 3. The mixer 74 is in fluid communication with the water supply 20 downstream of the first valve 66. The mixer 74 is fluidly coupled to the conduit 21 downstream of the valve 66 so that the flow of water downstream of the first valve 66 through the hydraulic mixer 74 causes the hydraulic mixer 74 to mix the water treatment solution 22 in the storage reservoir 30, i.e. rotate the stirrer 74A in the reservoir 30.

During the fill mode 1100, the valve 66 changes to the open position and directs the flow of water into the storage reservoir 30. The valve 66 therefore blocks the flow of water through the mixer 74 to the outlet 25. Once the storage reservoir 30 is at the first predetermined fill level 30A, the valve 66 changes to the closed position and directs the flow of water to the outlet 25.

In the illustrative embodiment, the water treatment system 10 my further include a bypass conduit 27 as shown in FIG. 1. The flow through the conduits 21, 27 may be controlled using a plurality of valves.

In the illustrative embodiment, the water treatment system 10 is coupled to a power supply 15. The power supply 15 may be included in the system 10 in some embodiments. The power supply 15 is configured to supply power to the different components of the system 10.

Another embodiment of a water treatment system 10 in accordance with the present disclosure is shown in FIGS. 15A-22. The water treatment system 210 is substantially similar to the water treatment system 10 shown in FIGS. 1-14 and described herein. Accordingly, similar reference numbers in the 200 series indicate features that are common between the water treatment system 10 and the water treatment system 210. The description of the water treatment system 10 is incorporated by reference to apply to the water treatment system 210, except in instances when it conflicts with the specific description and the drawings of the water treatment system 210.

The water treatment system 210 includes a tank 212, a dispenser 214, and a control system 216 as shown in FIGS. 15A-22. The tank 212 is in fluid communication with the water supply 220 to receive a flow of water from the water supply 220. The dispenser 214 is configured to be coupled to the tank 212 and dispense the water treatment material 224 into a storage reservoir 230 of the tank 212. The control system 216 is configured to produce the water treatment solution 222 in the storage reservoir 230 of the tank 212 and to dose the water supply 220 with the water treatment solution 222 from the storage reservoir 230.

The tank 212 includes a tank housing 226 and a cartridge mount 228 coupled to the tank housing 226 as shown in FIGS. 15A-22. The tank housing 226 is formed to define the storage reservoir 230. The cartridge mount 228 is co is formed to include a transfer passageway 232P in fluid communication with the storage reservoir 230. The passageway 232P forms an inlet opening 232 arranged to open into the passageway 232P.

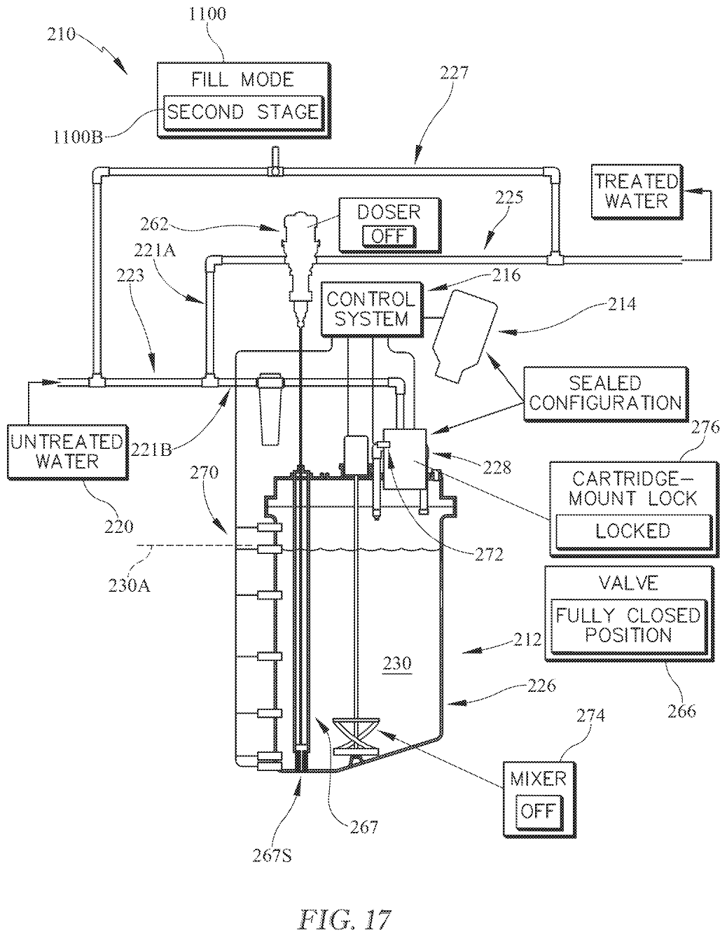

The cartridge mount 228 is configured to receive the dispenser 214 as shown in FIGS. 17, 32, and 33. The cartridge mount 228 and the dispenser 214 cooperate to dispense the water treatment material 224 into the storage reservoir 230 during refilling of the tank 212.

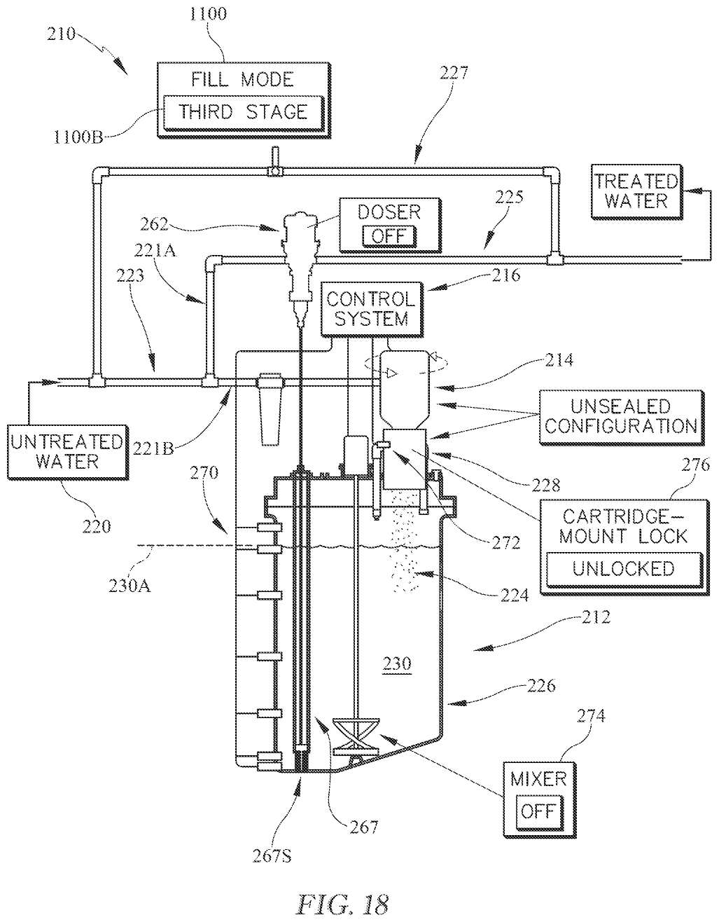

The cartridge mount 228 and the dispenser 214 are configured to change between a sealed configuration as shown in FIGS. 17, 36, and 38 and an unsealed configuration as shown in FIGS. 18-20, 37, and 39. In the sealed configuration, the water treatment solution 224 in the dispenser 214 is blocked from flowing through the passageway 232P into the storage reservoir 230. In the unsealed configuration, the water treatment solution 224 in the dispenser 214 is allowed to flow through the passageway 232P into the storage reservoir 230.

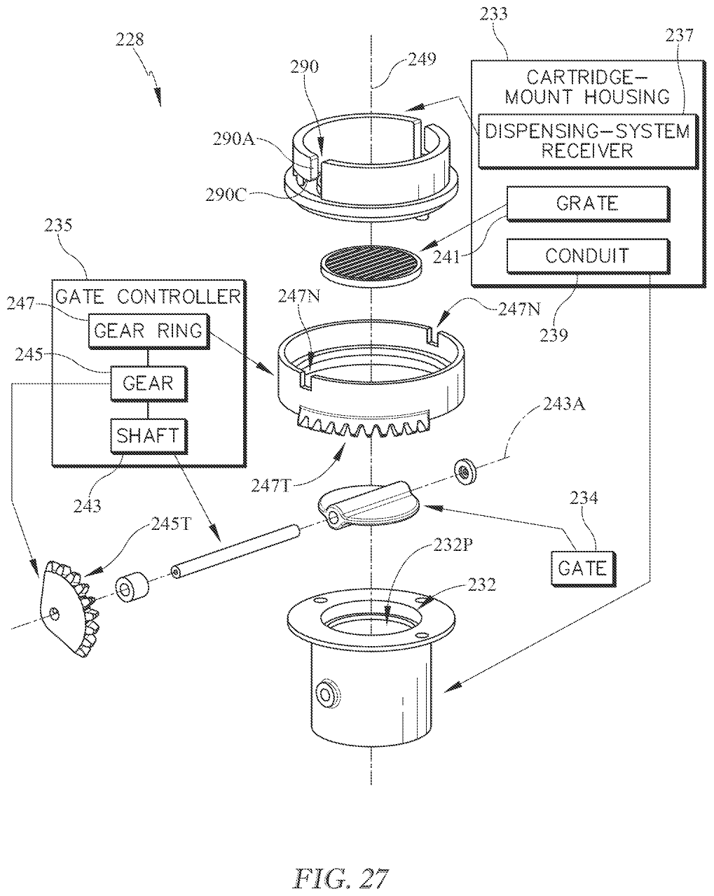

The cartridge mount 228 includes a cartridge-mount housing 233, a gate 234, and a gate controller 235 as shown in FIGS. 27-39. The cartridge-mount housing 233 is coupled to the tank housing 226 and is formed to include the transfer passageway 232P in fluid communication with the storage reservoir 230 of the tank housing 226. The gate 234 is mounted in the passageway 232P of the cartridge-mount housing 233. The gate 234 is configured to change between a closed position as shown in FIG. 28 to block access to the storage reservoir 230 and an open position as shown in FIG. 29 to allow access to the storage reservoir 230 through the tank opening 232 and the passageway 232P. The gate controller 235 is configured to control movement of the gate 234 between the closed and open positions.

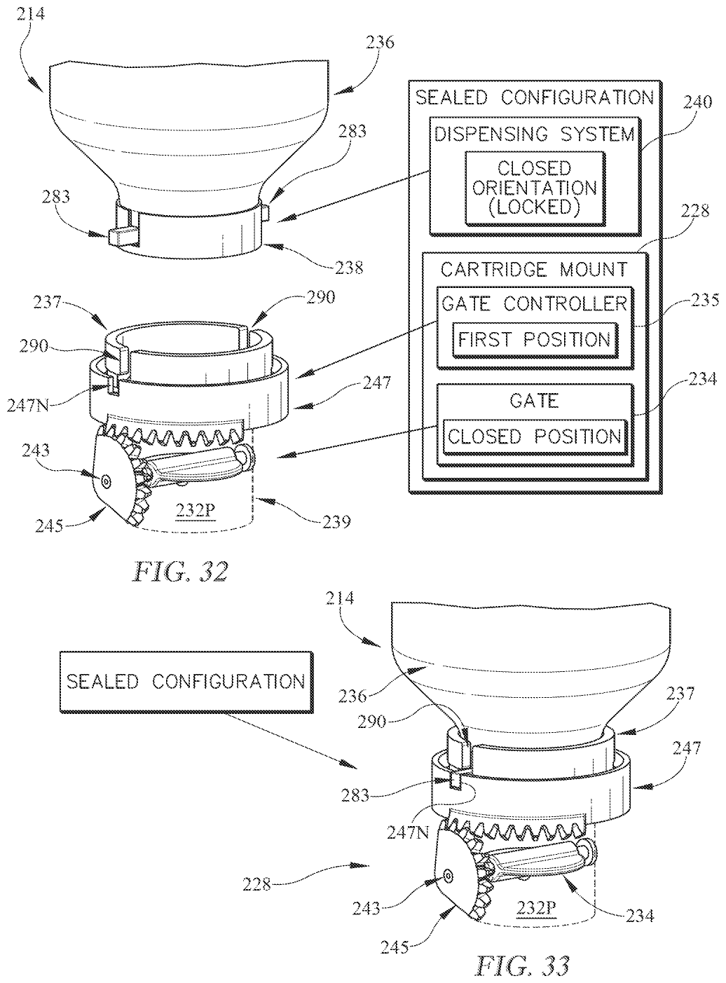

The gate 234 is in the closed position when the cartridge mount 228 and the dispenser 214 are in the sealed configuration as shown in FIG. 32-36. In the closed position, the gate 234 closes the tank opening 232 and blocks access to the storage reservoir 230 through the passageway 232P.

The gate 234 is in the open position when the cartridge mount 228 and the dispenser 214 are in the unsealed configuration as shown in FIG. 37. In the open position, the gate 234 has moved to allow access to the storage reservoir 230 through the tank opening 232 and the passageway 232P.

The cartridge-mount housing 233 includes a dispensing-system receiver 237 and a conduit 239 as shown in FIGS. 27-39. The dispensing-system receiver 237 is adapted to receive the end of the cartridge 236 with the dispensing system 240. The conduit 239 is arranged to extend between and interconnect the receiver 237 and the tank housing 226. The conduit 239 is formed to include the inlet opening 232 and the transfer passageway 232P.

In the illustrative embodiment, the cartridge-mount housing 233 further includes a grate 241 as shown in FIGS. 27, 30, and 31. The grate 241 is arranged between the receiver 237 and the conduit 239 over the opening 232 to partition the opening 232 in a plurality of smaller openings. The plurality of smaller openings helps distribute the water treatment material 224 across the opening 232 and the passageway 232P.

The gate 234 is mounted in the passageway 232P of the conduit 239 to control the flow of the water treatment material 224 through the passageway 232P into the storage reservoir 230. In the illustrative embodiment, the gate 234 is a butterfly valve as shown in FIGS. 28 and 29. In other embodiments, the gate 234 may be another suitable valve.

The gate controller 235 includes a shaft 243, a gear 245, and a gear ring 247 as shown in FIG. 27-39. The shaft 243 extends through the conduit 239 along a shaft axis 243A and is configured to rotate about the shaft axis 243A. The gate 234 is coupled to the shaft 243 for rotation therewith about the axis 243A. The gear 245 is coupled to an end of the shaft 243 outside of the conduit 239 to rotate with the shaft 243. The gear ring 247 is coupled to the mount housing 233 and configured to rotate relative to the mount housing 233 about a cartridge axis 249, or also referred to as a rotation axis 249, that is perpendicular to the shaft axis 243A.

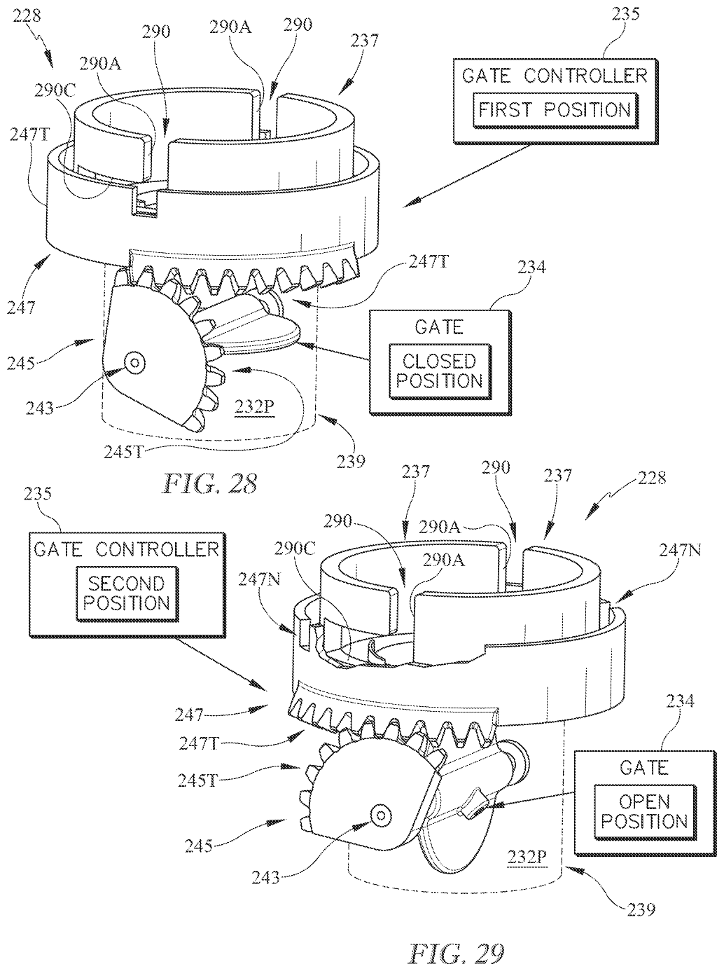

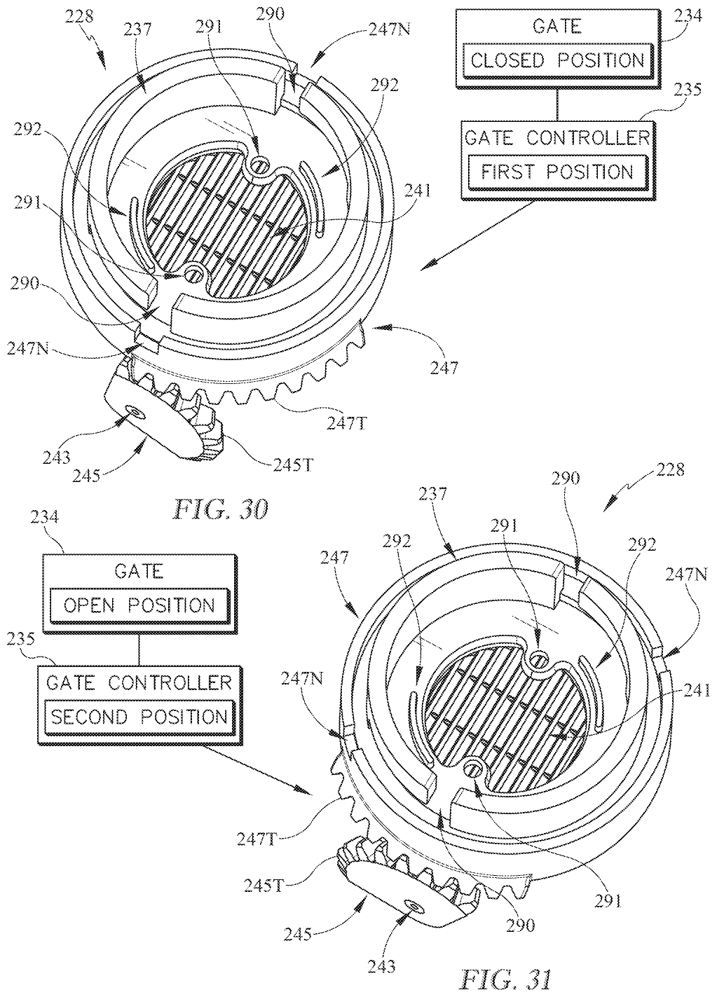

The gear ring 247 is configured to rotate about the cartridge axis 249 between a first position as shown in FIGS. 28 and 30 and a second position as shown in FIGS. 29 and 31. In the first position, the gate 234 is in the closed position. In the second position, the gate 234 is in the open position.

The gear 245 if formed to define teeth 245T that mate with teeth 247T formed on the gear ring 247 so that movement of the gear ring 247 drives movement of the gear 245 as shown in FIGS. 28-31. Rotation of the gear ring 247 about the cartridge axis 249 in a first direction from the first positon to the second position causes the gear 245 to rotate about the axis 243A in a first rotational direction as shown in FIGS. 28-31. Rotation of the gear 245 in the first rotational direction drives rotation of the shaft 243 to cause the gate 234 to change from the closed position to the open position.

Conversely, rotation of the gear ring 247 about the cartridge axis 249 in a second direction, i.e. opposite to the first direction, from the second positon back to the first position causes the gear 245 to rotate about the axis 243A in a second rotational direction. The second rotational direction is opposite to the first rotational direction. Rotation of the gear 245 in the second rotational direction drives rotation of the shaft 243 to cause the gate 234 to change from the open position to the closed position.

In the illustrative embodiment, when the dispenser 214 is inserted into the dispensing-system receiver 237 of the cartridge-mount housing 233, the dispenser 214 engages the gear ring 247 of the gate controller 235. In this way, rotation of the dispenser 214 in either the first direction or the second direction causes the gear ring 247 to rotate about the cartridge axis 249.

For example, if the dispenser 214 is rotated in the first direction, the rotation of the dispenser 214 causes the gear ring 247 to rotate therewith in the first direction from the first position to the second position. This in turn, drives rotation of the gear 245, and thus the gate 234 about the axis 243A in the first rotational direction from the closed position to the open position.

If the dispenser 214 is rotated in the second direction, the rotation of the dispenser 214 causes the gear ring 247 to rotated therewith in the second direction from the second position to the first position. This in turn, drives rotation of the gear 245, and thus the gate 234 about the axis 243A in the second rotational direction from the open position to the closed position.

By linking the dispenser 214 to the gate controller 235, the transfer passageway 232P will be closed off by the gate 234 whenever the dispenser 214 is not inserted into the cartridge-mount housing 233. In this way, the user cannot access the storage reservoir 230. Additionally, the cartridge-mount hosing 233 and the gate controller 235 cooperate to block removal of the dispenser 214 from the dispensing-system receiver 237 when the gear ring 247 is in the second position. This prevents any of the material and/or liquid inside from contacting the user during refiling.

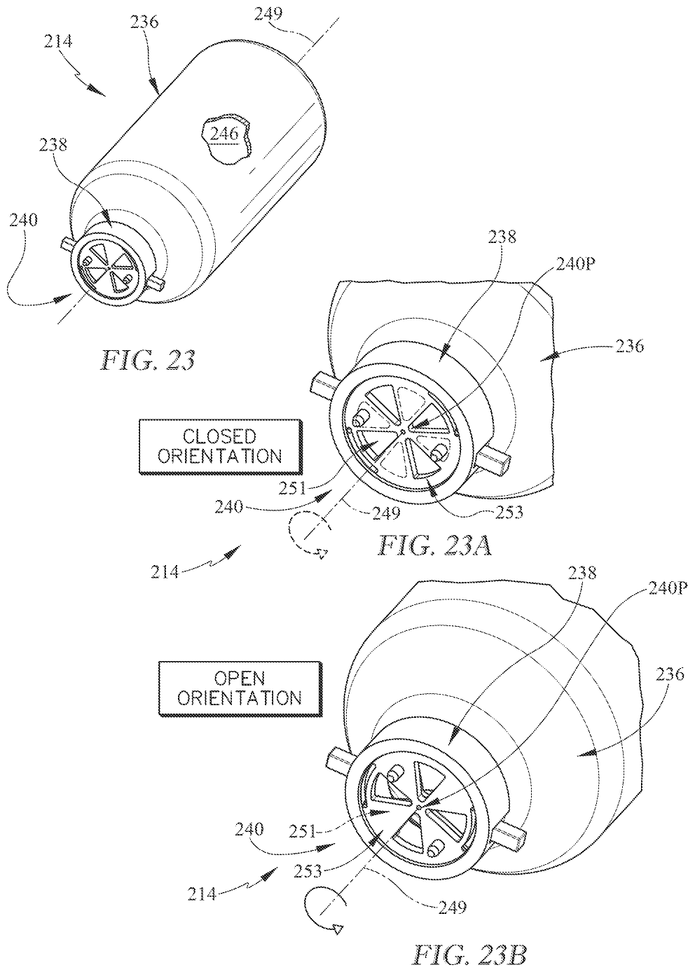

Turning again to the dispenser 214, the dispenser 214 includes a cartridge 236, a cap 238, and a dispensing system 240 as shown in FIGS. 23-26A. The cartridge 236 is shaped to define an interior storage region 246 that is configured to store the water treatment material 224. The cap 238 is coupled to the cartridge 236 to couple the dispensing system 240 to the cartridge 236. The dispensing system 240 is configured to block any water treatment material 224 from exiting the cartridge 236. The dispensing system 240 is configured to control the dispensing of the water treatment material 224 out of the cartridge 236.

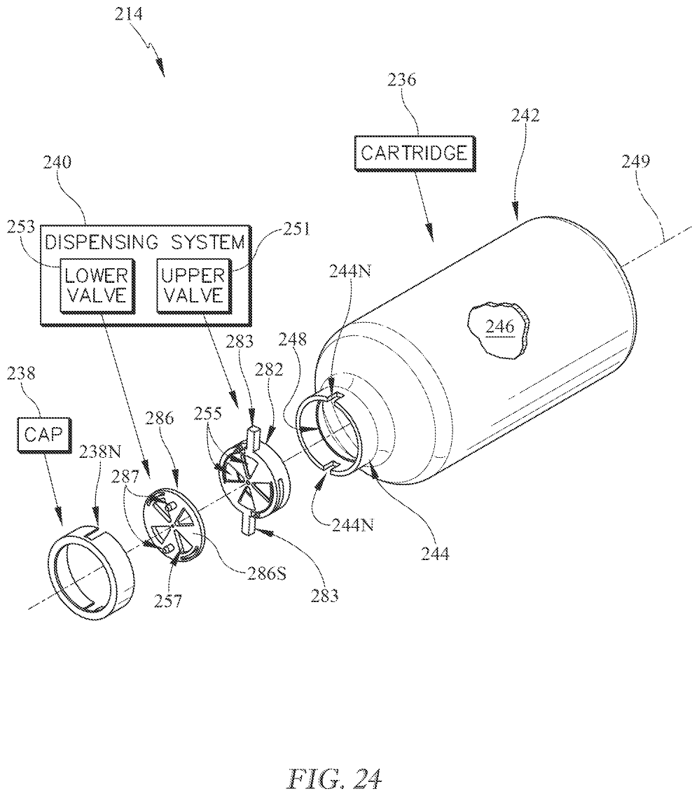

The cartridge 236 includes a body 242 and a neck 244 as shown in FIGS. 24, 38, and 39. The body 242 is formed to include the interior storage region 246 that stores the water treatment material 224. The neck 244 is coupled to the body 242 and formed to include an opening 248 arranged to open into the interior storage region 246. In the illustrative embodiment, the dispensing system 240 is configured to control the dispensing of the water treatment material 224 through the opening 248 in the neck 244 of the cartridge 236.

The dispensing system 240 includes an upper valve 251 and a lower valve 253 as shown in FIG. 23A-26A. The upper valve 251 is coupled to the neck 244 of the cartridge 236 and is arranged over the opening 248 formed by the neck 244 of the cartridge 236. The lower valve 253 is coupled to the upper valve 251 opposite the cartridge 236 at a pivot point 240P. The cap 255 extends over the upper and lower valves 251, 253 and couples to the neck 244 of the cartridge 236.

The upper and lower valves 251, 253 are each formed to include a plurality of openings 255, 257 as shown in FIGS. 23A-26A. The upper valve 251 is formed to include a plurality of upper openings 255 spaced apart circumferentially about the cartridge axis 249. The lower valve 253 is formed to include a plurality of lower openings 257 spaced apart circumferentially about the cartridge axis 249.

Normally, the upper and lower valves 251, 253 are fixed, or locked, relative to each other in a closed orientation as shown in FIGS. 23A and 38. In the closed orientation, the openings 257 formed in the lower valve 253 are offset from the openings 255 formed in the upper valve 251 so that the plurality of openings 255, 257 of each valve 251, 253 are covered to prevent water treatment material 224 from flowing out of the cartridge 236.

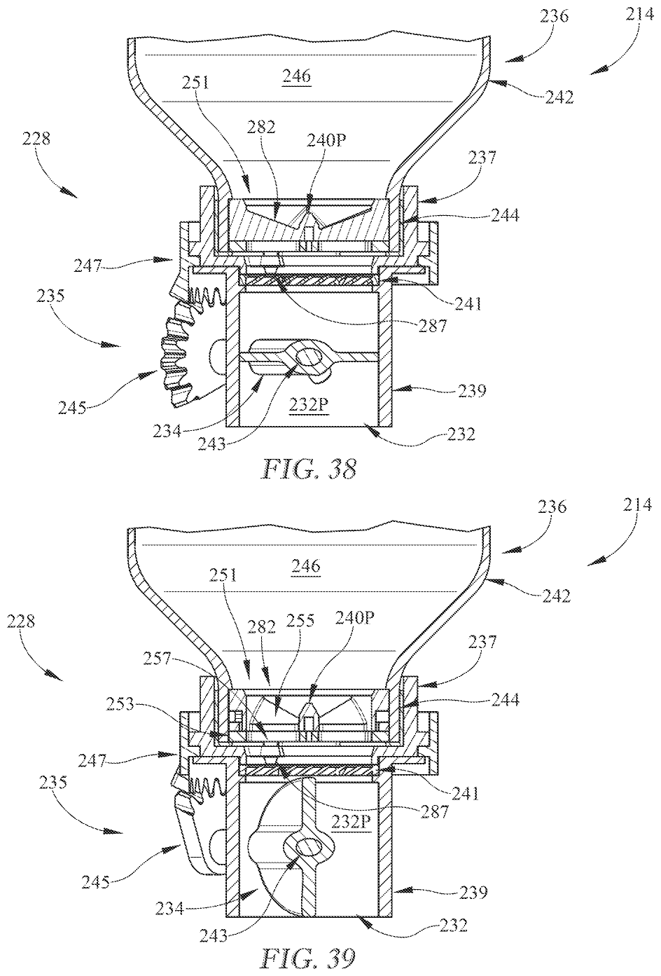

However, the lower valve 253 is configured to rotate relative to the upper valve 251, the cartridge 236, and the cap 238 about the cartridge axis 249 to an open orientation as shown in FIGS. 23B and 39. In the open orientation, the lower openings 257 in the lower valve 253 align with the upper openings 255 in the upper valve 251 to allow the water treatment material 224 to flow out of the cartridge 236.

To dispense the water treatment material 224, the cartridge 236 is inserted into the dispensing-system receiver 237 of the cartridge mount 228 as shown in FIGS. 32 and 33. Insertion of the cartridge 236 into the dispensing-system receiver 237 unlocks the lower valve 253 from the upper valve 251 to allow the lower valve 253 to rotate about the cartridge axis 249. Rotation of the cartridge 236 in the first direction causes the lower valve 251 to change from the closed orientation to the open orientation. In this way, the upper openings 255 in the upper valve 251 align with the lower openings 257 in the lower valve 253 to allow the water treatment material 224 to flow out of the cartridge 236.

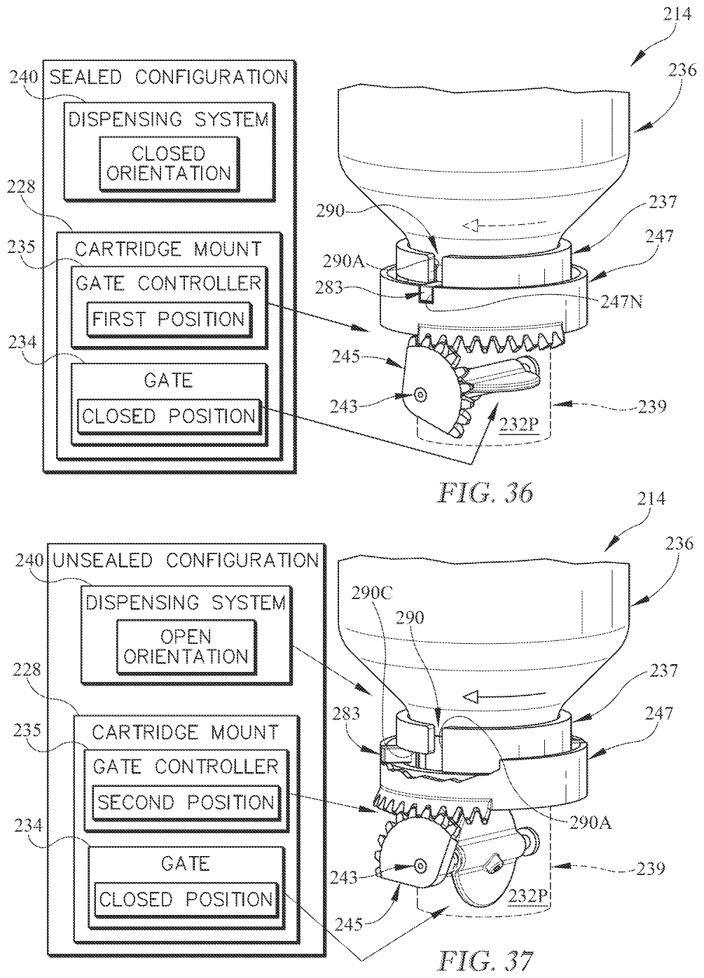

As discussed above, the dispenser 214 cooperates with the gate controller 235 of the cartridge mount 228 to control dispensing of the water treatment material 224 into the tank housing 226 as shown in FIGS. 36-39. In the sealed configuration, the gate 234 is in the closed position, the gear ring 247 of the gate controller 235 is in the first position, and the dispensing system 240 is in the closed orientation to prevent any water treatment material 224 from being dispensed in the storage reservoir 230. In the unsealed configuration, the gate 234 is in the open position, the gear ring 247 of the gate controller 235 is in the second position, and the dispensing system 240 is in the open orientation to allow the water treatment material to be dispensed into the storage reservoir 230. In the unsealed configuration, the dispenser 214 is also blocked from axial movement along the cartridge axis 249 relative to the cartridge mount 228.

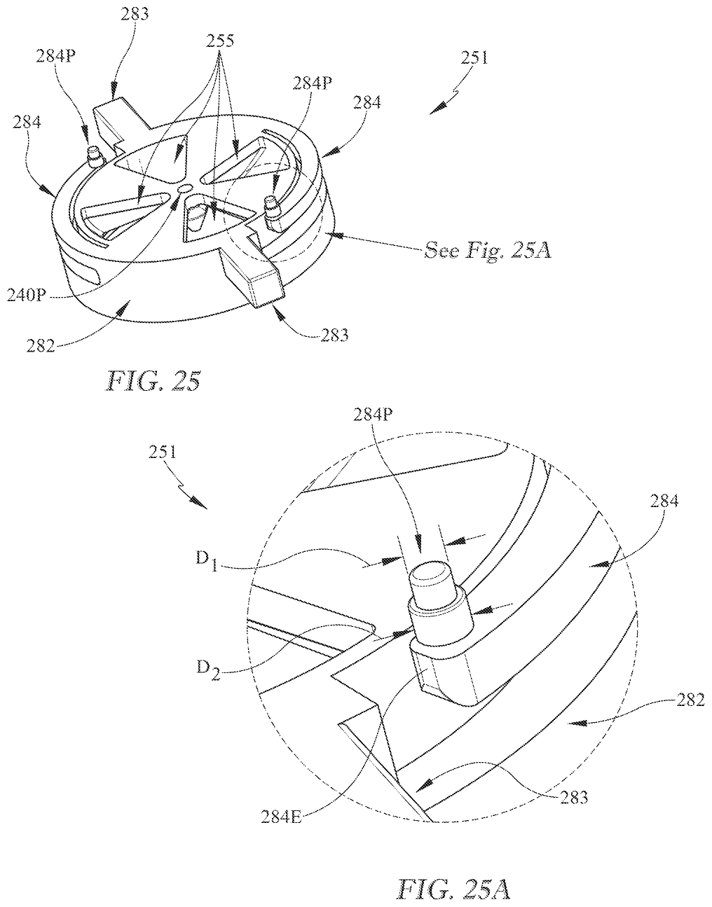

The upper valve 251 further includes a main body 282, engagement flanges 283, and spring arms 284 as shown in FIGS. 25 and 25A. The main body 282 is formed to include the plurality of upper openings 255. The engagement flanges 283 extend radially away from the main body 282 on opposite sides of the main body 282 relative to the cartridge axis 249. The spring arms 284 extend from the main body 282 and are configured to deflect axially relative to the cartridge axis 249.

In the illustrative embodiment, each spring arm 284 is formed to include a locking pin 284P that extends axially relative to the cartridge axis 249 as shown in FIGS. 25 and 25A. Each of the locking pins 284P are formed on a terminal end 284E of the spring arms 284.

In the illustrative embodiment, the neck 244 of the cartridge 236 has notches 244N and the cap 238 has notches 238N for the engagement flanges 283 to extend through the cartridge 236 as shown in FIG. 24. In this way, when the upper valve 251 is arranged in the opening 248, the engagement flanges 283 extend therethrough.

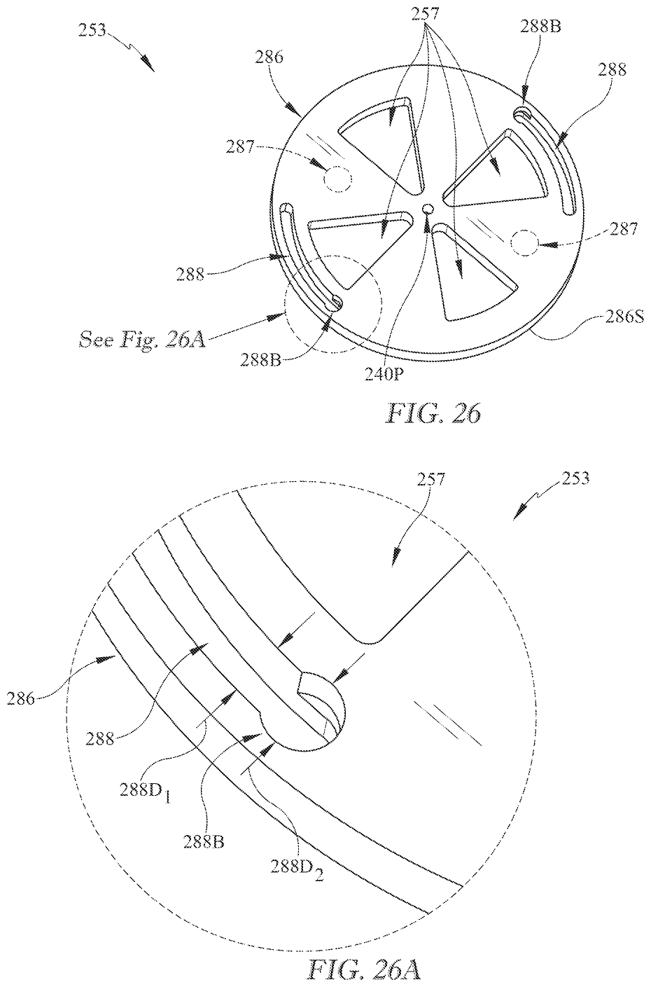

The lower valve 253 further includes a planar body 286, alignment pins 287, and guide slots 288 as shown in FIGS. 26 and 26A. The planar body 286 is formed to include the plurality of lower openings 257. The alignment pins 287 extend from a lower surface 286S of the planar body 286 away from the upper valve 251. The guide slots 288 extend axially through the planar body 286 relative to the cartridge axis 249 and extend circumferentially at least part way about the axis 249. Each of the guide slots 288 are configured to receive the locking pin 284P of the corresponding spring arm 284 of the upper valve 251 to fix the upper and lower valves 251, 253 relative to each other.

In the illustrative embodiment, each of the guide slots 288 has a counterbore 288B at one end of the guide slots 288 as shown in FIGS. 26 and 26A. The counterbore 288B has a greater diameter 288D₂ than the diameter 288D₁ of the slot 288 as shown in FIG. 26A.

In the illustrative embodiment, the locking pin 284P has two diameters as shown in FIG. 25A. The first diameter D₁ is equal to the diameter 288D₁ of the slot 288. The second diameter D₂ is equal to the diameter 288D₂ of the couterbore 288D. In this way, when the locking pin 284P is located in the counterbore 288D, the locking pin 284P blocks the rotation of the dispensing system between the open and closed orientations because the locking pin 284P with the larger diameter D₂ cannot fit in the guide slot 288.

However, when the spring arm 284 is deflected from the locked position to the unlocked position, the portion of the locking pin 284P with the larger diameter D₂ is moved out of the counterbore 288B and the portion of the locking pin 284 with smaller diameter D₁ is in the guide slot 288. The dispensing system is thus free to change between the open and closed orientations.

The dispensing-system receiver 237 is shaped to include flange-receiving slots 290, alignment pinholes 291, and ribs 292 as shown in FIGS. 30, 31, and 34A. Each of the flange-receiving slots 290 are configured to receive the corresponding engagement flange 283 of the upper valve 251. A portion of the flange-receiving slots 290 are configured to be aligned with notches 247N formed in the gear ring 247 when the gear ring 247 of the gate controller 235 in the first position. Each of the alignment pinholes 291 are configured to receive the corresponding alignment pin 287 of the lower valve 253. Each of the ribs 292 are configured to extend into the corresponding slot 288 of the lower valve 253.

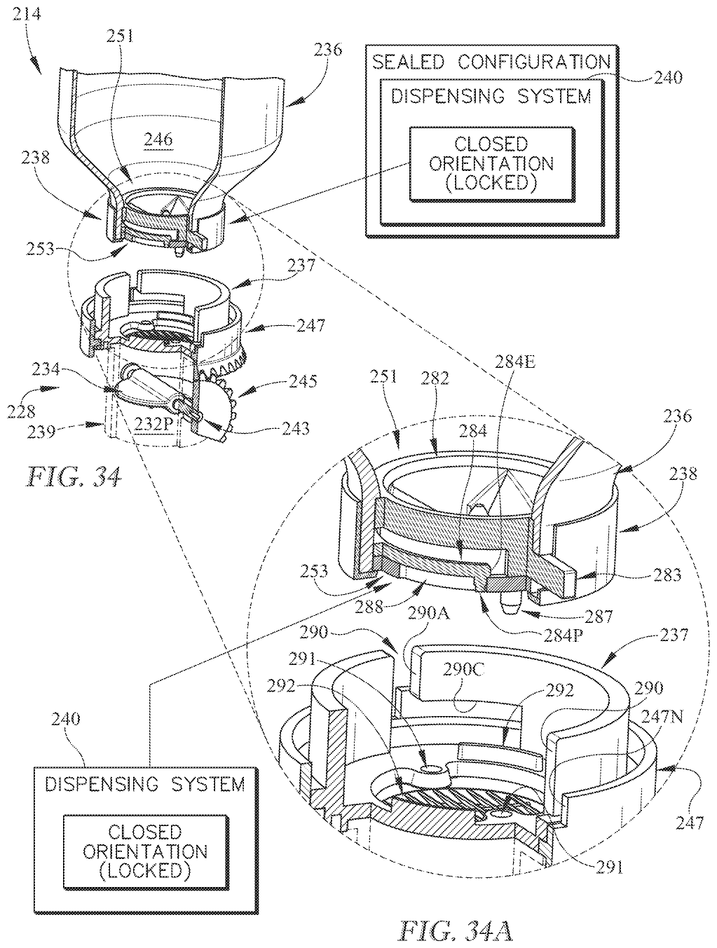

The end of the cartridge 236 with the dispensing system 240 may be inserted in the cartridge mount 228 when the cartridge mount 228 and the dispenser 214 are in the sealed configuration. Before the dispensing system 240 is inserted in the cartridge mount 228, the lower valve 253 is locked relative to the upper valve 251 and blocked from rotating relative to the upper valve 251 as shown in FIGS. 32, 34, and 34A.

As the dispensing system 240 is inserted in the cartridge mount 228, the engagement flanges 283 extend into the flange-receiving slots 290 and the notches 247N as shown in FIG. 33. Simultaneously, the alignment pins 287 extend into the alignment pin holes 291 to block rotation of the lower valve 253.

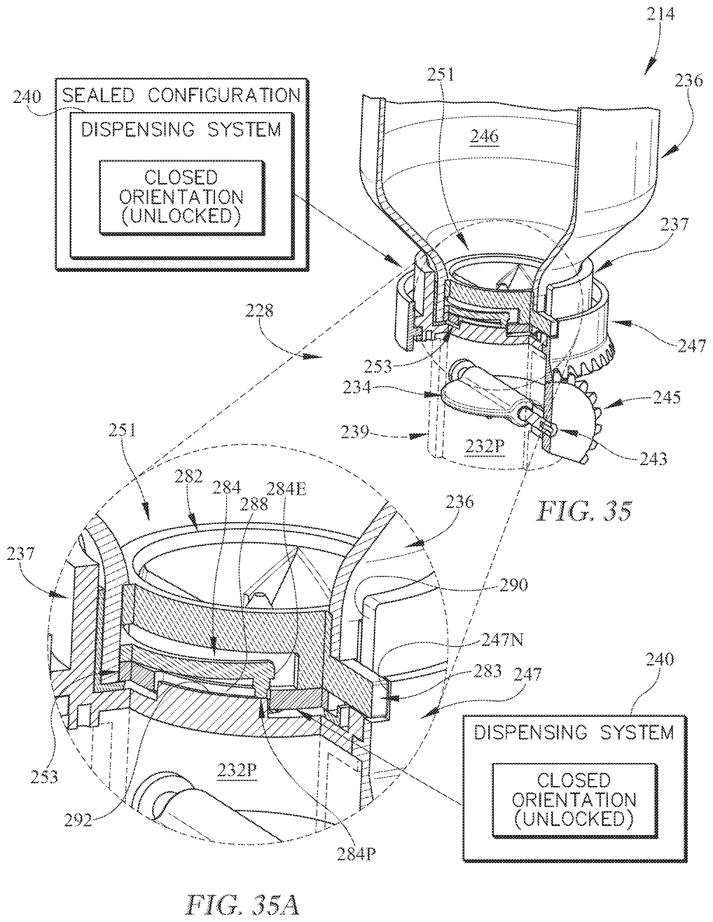

Additionally, the ribs 292 simultaneously extend into the spring-arm slots 288 as the dispensing system 240 is inserted in the cartridge mount 228 as shown in FIGS. 34-35A. As the ribs 292 extend into the corresponding spring-arm slots 288, the ribs 292 engage the locking pins 284P of the spring arms 284. This causes the spring arms 284 to deflect and disengage the lower valve 253 so that the lower valve 253 is unlocked from the upper valve 251 and free to rotate relative to the upper valve 251 as shown in FIGS. 35 and 35A.

In the illustrative embodiment, the flange-receiving slots 290 extend axially partway into the dispensing-system receiver 237 and circumferentially partway around the axis 249 as shown in FIGS. 29 and 37. When the gear ring 247 is in the first position, the notches 247N align with the axial portion 290A of the flange-receiving slots 290 so that the engagement flanges 283 may extend into the flange-receiving slots 290 and the notches 247N as shown in FIG. 36.

Then, when the cartridge 236 is rotated in the first direction, the engagement flanges 290 move along the circumferential portion 290C of the flange-receiving slots 290 as shown in FIG. 37. Simultaneously, the engagement flanges 290 engage with the gear ring 247 in the notches 247N to cause the gear ring 247 to rotate in the first direction about the axis 249 to the second position. Thus, the dispensing-system receiver 237 engages the engagement flanges 290 of the dispensing system 240 so as to block axial movement of the dispenser 214 along the axis 249 and prevent removal of the dispenser 214 while the cartridge mount 228 and the dispenser 214 are in the unsealed configuration.

The control system 216 comprises a doser 262 in fluid communication with the storage reservoir 230 and the water supply 20 and a controller 264 coupled to the doser 262 as shown in FIGS. 15A-22. The doser 262 is in fluid communication with a dosing line 267 located in the storage reservoir 230 of the tank 212. The doser 262 is configured to dose the water supply 220 with the water treatment solution 222. The controller 264 is configured to direct the doser 262 to dose a predetermined amount of the water treatment solution 222 into the water supply 220 so that the water treatment solution 222 reacts with the hard minerals in the water supply 220 thereby reducing the water hardness.

In the illustrative embodiment, the dosing line 267 has a protective housing 267H and a screen filter 267S as shown in FIG. 15A-22. The protective housing 267 surrounds the dosing line 267. The screen filter 267S is coupled to an end of the dosing line 267 at the bottom of the storage reservoir 230 to prevent other material that may have somehow entered the tank 212 from being flowing through the dosing line 267 to the doser 262.

The control system 216 further includes an inlet valve 266, sensors 270, 272, a mixer 274, and a cartridge-mount lock 276 as shown in FIGS. 15A-22. The valve 266 controls the flow of water into the storage reservoir 230. The sensors 270, 272 are configured to detect aspects of the system 210 and provide feedback to the controller 264. The mixer 274 is located in the storage reservoir 230. The mixer 274 is configured to mix the water treatment solution 222 in the storage reservoir 230 to prevent the water treatment solution 220 from settling in the storage reservoir 230. The cartridge-mount lock 276 is coupled to the cartridge mount 228 and is configured to block rotation of the gate controller 235 when no dispenser 214 is inserted into the dispensing-system receiver 237 of the cartridge mount 228.

In the illustrative embodiment, the control system 216 further includes a UV light 271 as shown in FIG. 15C. The UV light 271 is located in the storage reservoir 230 and is coupled to the controller 264. The UV light 271 is configured to emit a UV light in the storage reservoir 230 to kill microbes (e.g. bacteria, fungi, yeast, and the like) in the storage reservoir 230.

In other embodiments, the control system 216 may not include a UV light 271. Depending on the concentration level of the water treatment solution 222, the UV light 271 may not be needed to kill in the storage reservoir 230. If a lower concentration of the water treatment solution 222 is used to dose the water supply 220, the UV light may be needed to kill microbes in the storage reservoir 230.

The sensors 270, 272 include level sensor 270 and a cartridge sensor 272 as shown in FIGS. 15A-22. The level sensor 270 and the cartridge sensor 272 are each coupled to the controller 264. The level sensor 270 are located in the storage reservoir 230 and is configured to measure a fill level 230A-230G of the water treatment solution 222 in the storage reservoir 230. The cartridge sensor 272 is coupled to the cartridge mount 228 and is configured to detect if the dispenser 214 is coupled to the cartridge mount 228.

In the illustrative embodiment, the cartridge sensor 272 is an RFID sensor. The dispenser 214 includes an RFID tag and the sensor 272 is configured to detect the RFID tag on the dispenser 214 to provide feedback to the controller 264 of when a new dispenser 214 is inserted into the cartridge mount 228.

In other embodiments, the cartridge sensor 272 may be another suitable sensor, such as a pressure sensor. The pressure sensor may be configured to detect the weight of the dispenser 214 in some embodiments. In other embodiments, the pressure sensor may be a spring/level system configured to depress/disengage in response to the weight of the dispenser 214 and allow the dispenser 214 to be rotated.

The level sensor 270 is configured to measure a plurality of fill levels of the tank 212 as shown in FIG. 15C. The level sensor 270 is configured to measure the maximum volume of the reservoir 230 with the water treatment solution 222, i.e. fill level 230B. The level sensor 270 is configured to measure when the tank 212 is at about 97%/96.7% of the maximum volume of the reservoir 230, i.e. fill level 230A. The level sensor 270 is configured to measure when the tank 212 is at about 75% of the maximum volume of the reservoir 230, i.e. fill level 230E. The level sensor 270 is configured to measure when the tank 212 is at about 50% of the maximum volume of the reservoir 230, i.e. fill level 230F. The level sensor 270 is configured to measure when the tank 212 is at about 25% of the maximum volume of the reservoir 230, i.e. fill level 230G. The level sensor 270 is configured to measure when the tank 212 is at about 3%/2.7% of the maximum volume of the reservoir 230, i.e. fill level 230D. The level sensor 270 is configured to measure when the tank 212 is at about 0% of the maximum volume of the reservoir 230, i.e. fill level 230C.

The cartridge-mount lock 276 is coupled to the controller 264 and is configured to change between a locked position and an unlocked position based on the feedback from the cartridge sensor 272 as shown in FIGS. 17-19. The cartridge-mount lock 276 is normally in the locked position to block rotation of the gate controller 235 when the cartridge sensor 272 fails to detect the RFID tag of the dispenser 214. This could mean no dispenser 214 is inserted into the cartridge mount 228 or a counterfeit cartridge may be inserted. This prevents unwanted material from being dispensed into the tank 212.

When the cartridge sensor 272 detects the RFID tag of the dispenser 214, the controller 264 directs the cartridge-mount lock 276 to change from the locked position to the unlocked position. In the unlocked position, the cartridge-mount lock 276 is spaced apart from the gate controller 235 so that gate controller 235 is free to rotate to allow a user to dispenser the water treatment material 224.

The inlet valve 266 is coupled to a tank inlet conduit 265 so that the valve 266 is in fluid communication with the water supply 220 and the storage reservoir 230 as shown in FIG. 15B-22. The valve 266 is in fluid communication with a fill conduit 265F and a flush conduit 269. Both the fill conduit 265F and the flush conduit 269 are in fluid communication with the storage reservoir 230.

The valve 266 is configured to control the flow of water to the fill conduit 265F and/or the flush conduit 269. The fill conduit 265F is unrestricted so as to quickly fill the storage reservoir 230 of the tank 212. The flush conduit 269 has a spray nozzle 269N so that when water is directed through the flush conduit 269 the water is sprayed by the nozzle 269N to flush the storage reservoir 230 of any residual water treatment solution 222 between refills of the tank 212.

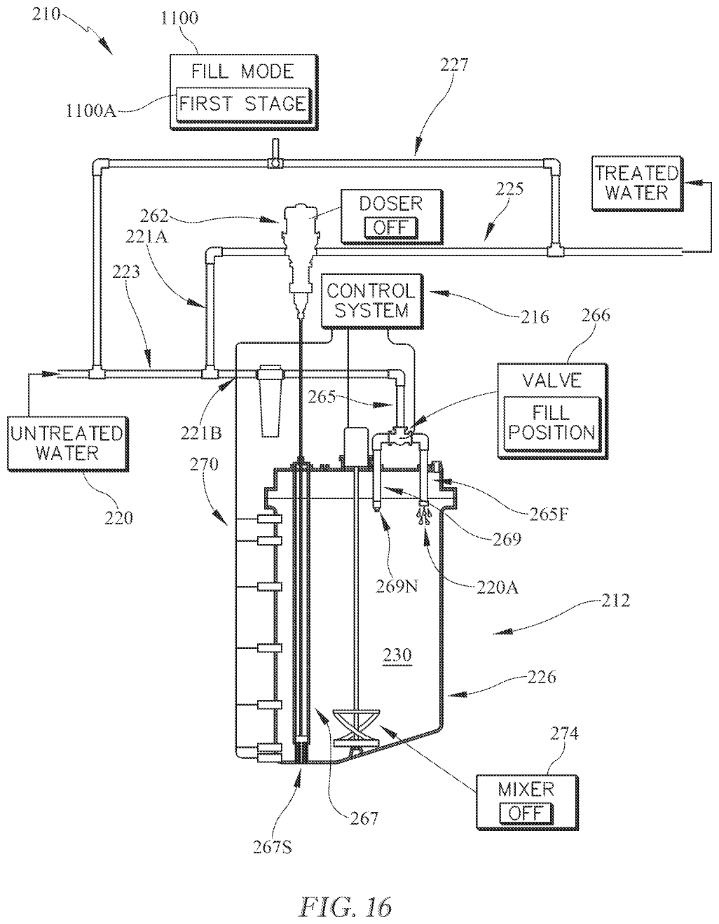

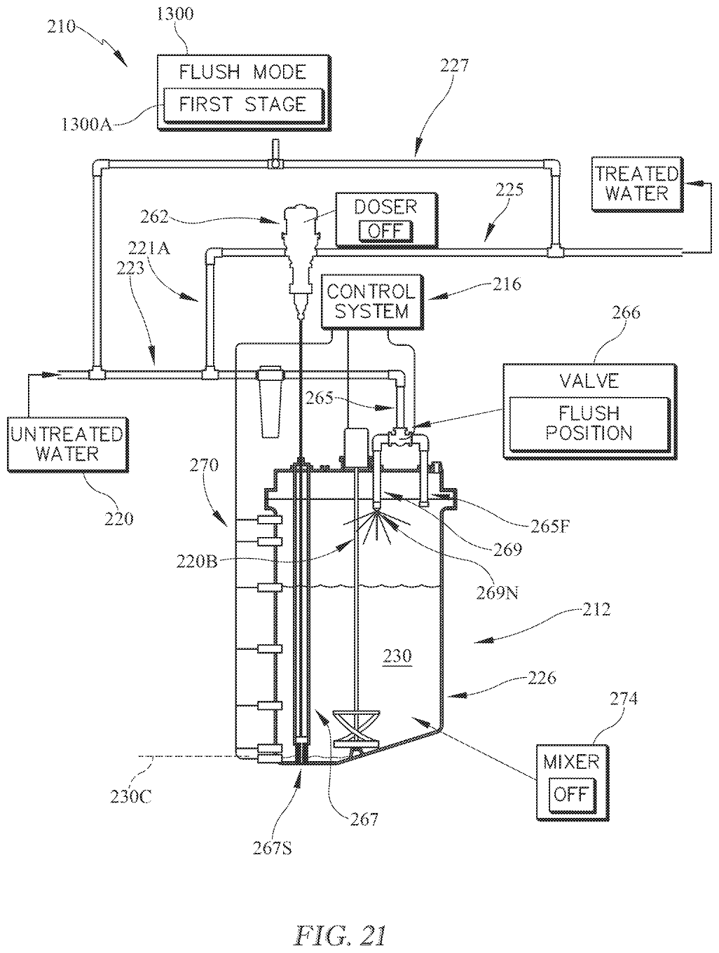

The valve 266 is configured to change between a fully closed position, a fill position, and a flush position. In the fully closed position, the valve 266 blocks the flow of water through the fill conduit 265F and the flush conduit 269 to prevent water from being added to the storage reservoir 230 as shown in FIG. 17. In the fill position, the valve 266 directs the flow of water through the fill conduit 265F and blocks the flow of water through the fill conduit 265F as shown in FIG. 16. In the flush position, the valve 266 directs the flow of water through the flush conduit 269 and blocks the flow of water through the fill conduit 265F as shown in FIG. 21.

In the illustrative embodiment, the inlet valve 266 is a solenoid valve 266. The controller 264 is configured to direct the valve 266 to change between the fully closed position, the fill position, and the flush position based on the mode of the system 210. The controller 264 is configured to direct the inlet valve 266 to change between the restricted, fill, and flush positions to vary the flow of water into the storage reservoir 30 based on the fill level 230A-230G measured by the fill sensor 270.

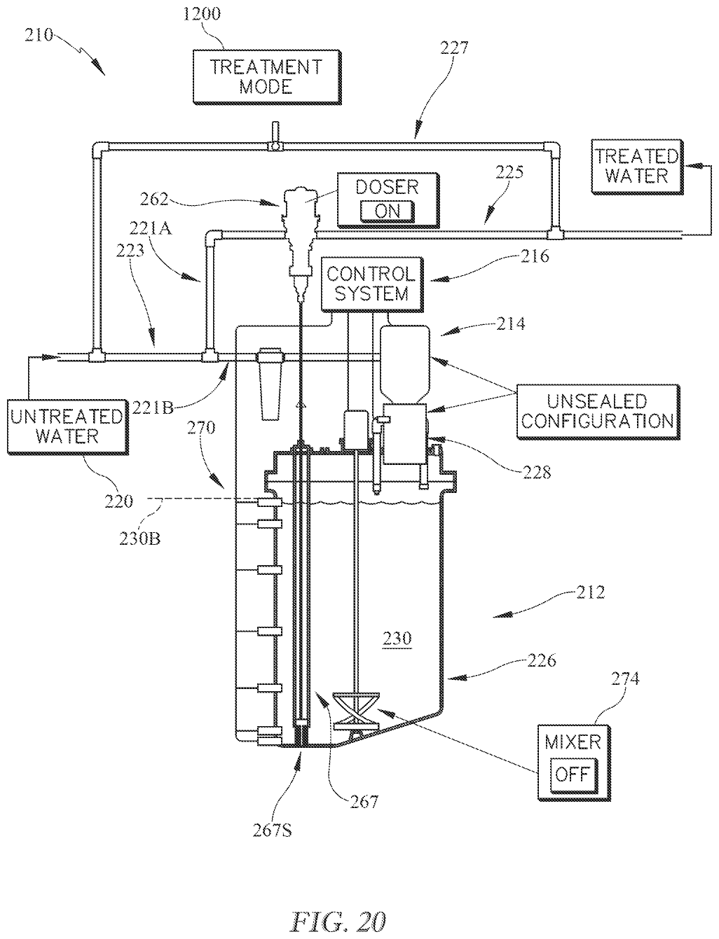

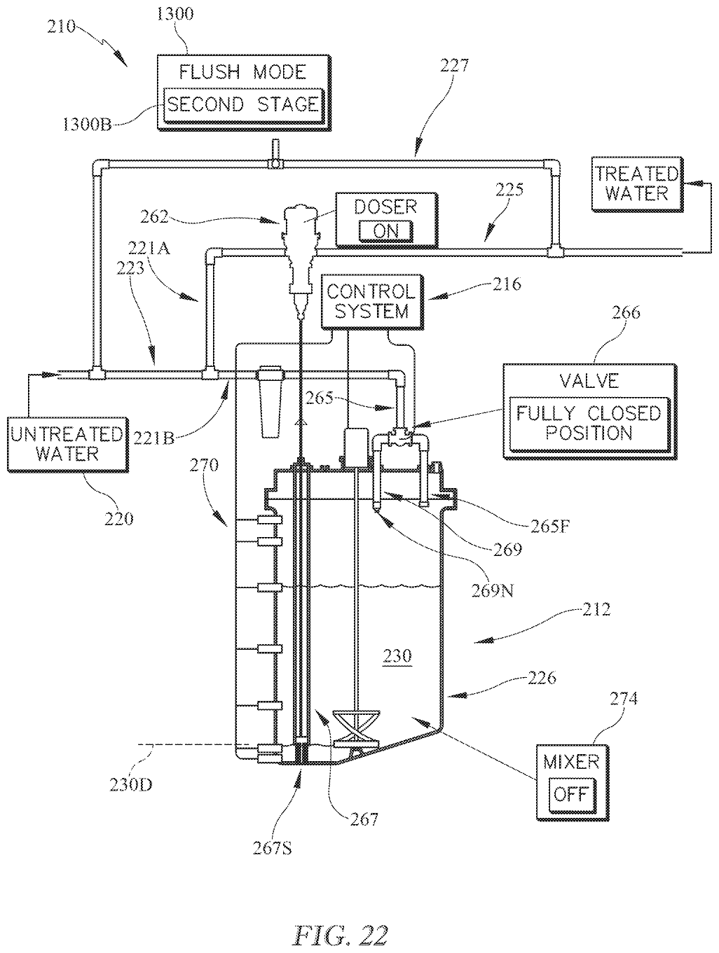

The system 210 is similar to the system 10 in FIGS. 1-14 in that the system 210 is configured to operate in three different modes: a fill mode 1100 as shown in FIGS. 16-19 a treatment mode 1200 as shown in FIG. 20, and a flush mode 1300 as shown in FIGS. 21 and 22. The fill mode 1100 is when the reservoir of the water treatment solution 222 in the tank 212 needs to be replenished. The treatment mode 1200 is when the water treatment solution 222 is dosed into the water supply 220. The flush mode 1300 is after the reservoir of the water treatment solution 222 is depleted and before the fill mode 1100 so as to flush out any remaining fluid in the storage reservoir 230 and clean the tank 212. The stages 1100, 1200, 1300 are repeated to refill whenever the water treatment solution reservoir becomes depleted.

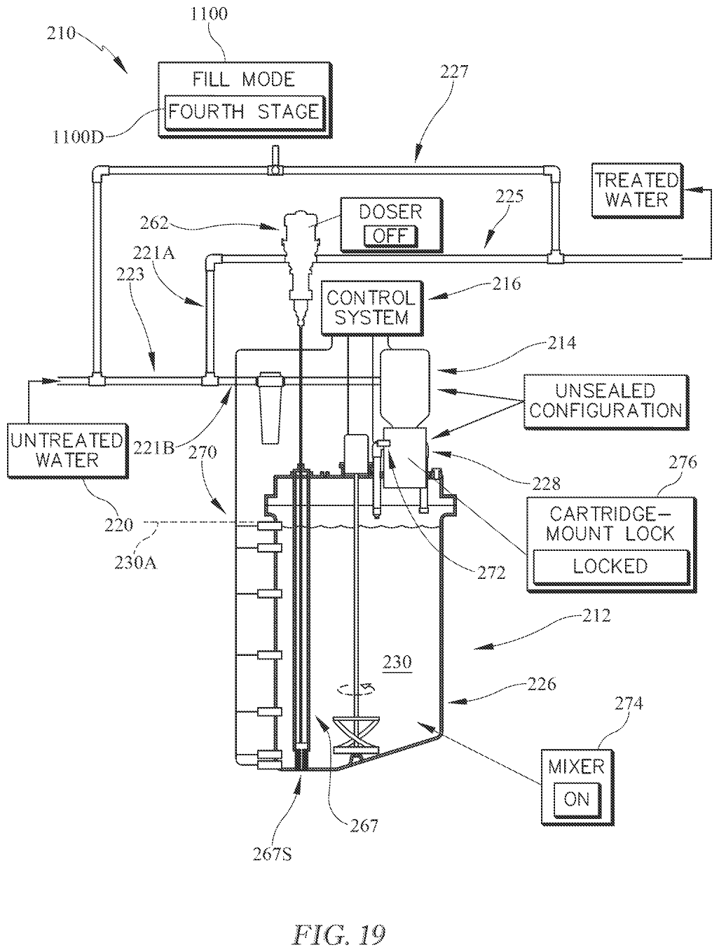

The fill mode 1100 includes three stages: a first stage 1100A as shown in FIG. 16, a second stage 1100B as shown in FIG. 17, a third stage 11000 as shown in FIG. 18, and a fourth stage 1100D as shown in FIG. 19. In first stage 1100A of the fill mode 1100, the storage reservoir 230 is empty and the controller 264 directs the inlet valve 266 to change to the fill position to allow a first flow of water 220A from the water supply 220 into the tank 212 through the fill conduit 265F. The inlet valve 266 remains in the fill position until the fill sensor 270 detects a first predetermined fill level 230A in the storage reservoir 230. Once the fill sensor 270 detects the first predetermined fill level 230A in the storage reservoir 230, the controller 264 directs the inlet valve 266 to change to the fully closed position.

In the second stage 1100B of the fill mode 1100, the user is directed to replace the old empty dispenser 214 with a new full dispenser 214 containing the water treatment material 224, or citric acid powder to be added to the tank 212. To do so, the user may need to remove the old empty dispenser 214 from the cartridge mount 228. To remove the old empty dispenser 214 the cartridge 236 is rotated in the second direction to cause the gate controller 235 to move to the first position, which in turn causes the gate 234 to move to the closed position. Simultaneously, rotation of the cartridge 236 causes the dispensing system 240 to change to the closed orientation. When the gate controller 235 in the first position, the dispensing system 240 is free to be removed from the cartridge mount 228.

The user then inserts the new full dispenser 214 to the cartridge mount 228 for dispensing. To insert the dispenser 214 the user must align the alignment pins 287 with the alignment pinholes 291 in the dispensing-system receiver 237. This simultaneously aligns the engagement flanges 283 with the flange-receiving slots 290 so that the new full dispenser 214 may be inserted into the dispensing-system receiver 237 of the cartridge mount 228 as shown in FIGS. 32 and 33.

By inserting the dispenser 214, the cartridge sensor 272 determines if the dispenser 214 is coupled to the cartridge mount 228 by detecting the RFID tag of the dispenser 214. If the sensor 272 detects the RFID tag of the dispenser 214, the controller 264 directs the cartridge-mount lock 276 to move to the unlocked position so that the gate controller 235 is free to rotated so that the water treatment material 224 is ready to be dispensed.

In the third stage 11000 of the fill mode 1100, the user is directed to the add the water treatment material 224 to the storage reservoir 230 by the rotating the dispenser 214 to cause the cartridge mount 228 and the dispenser 214 to change from the sealed configuration to the unsealed configuration as shown in FIG. 18. After inserting the dispenser 214, the user applies a downward axial force that causes the spring-arms 284 to deflect partially out of the guide slots 288, thereby unlocking the lower valve 253 from the upper valve 251 as shown in FIGS. 34-35A.

Then, while still applying the downward axial force, the user rotates the dispenser 214 in the first direction as shown in FIGS. 36 and 37. Rotation of the dispenser 214 in the first direction causes the cartridge mount 228 and the dispenser 214 to change from the sealed configuration to the unsealed configuration to allow the water treatment material to be dispensed into the storage reservoir 230. In other words, gear ring 247 of the gate controller 235 changes to the second position causing the gate 234 to change to the open position and the dispensing system 240 changes to the open orientation.

In the illustrative embodiment, the controller 264 directs the cartridge-mount lock 276 to move to the locked position so that the gate controller 235 is blocked from rotating thereby blocking rotation of the dispenser 214 while the water treatment material 224 is dispensed. In some embodiments, rotation of the dispenser 214 causes the cartridge-mount lock 276 to move back to the locked position thereby blocking rotation of the dispenser 214.

Once the water treatment material 224 is dispensed into the storage reservoir 230, the fill sensor 270 detects a second predetermined fill level 230B in the storage reservoir 30. In the illustrative embodiment, the dispenser 214 should be empty when the fill sensor 270 detects a second predetermined fill level 230B in the storage reservoir 230.

Once the fill sensor 270 detects the second predetermined fill level 230B in the storage reservoir 230, the controller 264 indicates the system 210 is in the fourth stage 1100D, or the mixing cycle of the file mode 1100 as shown in FIG. 19. During the fourth stage 1100D, the controller 264 directs the mixer 274 to change from an off mode to an on mode. In the on mode, the motor 274M coupled to the mixer 274 is directed to mix the water and the water treatment material 224 together to completely dissolve the water treatment material 224 in the water and produce the water treatment solution 222.

In the illustrative embodiment, the mixer 274 includes a stirrer 274A which extends into the storage reservoir 230 as shown in FIG. 15C. The stirrer 274A is supported by a bearing 274B coupled to the bottom of the tank housing 226.

The controller 264 runs the fourth stage 1100D or the mixing cycle for a predetermined mixing period. In the illustrative embodiment, the predetermined mixing period is greater than or equal to about three minutes.

Once the fourth stage 1100D of the fill mode 1100 has completed, the controller 264 directs the cartridge-mount lock 276 to move to the unlocked position to release the dispenser 214 for removal and the controller 264 indicates the system 210 is now in the treatment mode 11001B. The user is then directed to remove the dispenser 214, and the controller 64 directs the system 10 to begin the treatment mode 1200.

In the treatment mode 1200, the controller 264 directs the doser 262 to dose the predetermined amount of the water treatment solution 222 into the water supply 220. The controller 264 directs the doser 262 to dose the predetermined amount of the water treatment solution 222 at a predetermined flow rate based on the water flow rate through the conduit 221. The doser 262 is configured to detect the water flow rate and to dose the predetermined amount of water treatment solution 222 a proportional flow rate based on the water flow rate. The doser 262 is configured to vary the dosing flow rate depending on changes of the water flow rate.

When the fill sensor 270 detects a third predetermined fill level 230C in the storage reservoir 230 that corresponds to the reservoir 230 being depleted or empty, the treatment mode 1200 is ended. The controller 264 then begins the flush mode 1300 as shown in FIGS. 20 and 21.

The flush mode 1300 includes two stages: a first stage 1300A and a second stage 1300B as shown in FIGS. 20 and 21. In the first stage 1300A of the flush mode 1300, as shown in FIG. 20, the controller 264 directs the valve 266 to change to the flush position. In the flush position, the valve 266 directs a second flow of water 220B through the flush conduit 269 into the reservoir 230 to flush out the tank 212 after the third predetermined fill level is detected by the fill sensor 270.

The first valve 266 remains in the flush position until the fill sensor 270 detects a fourth predetermined fill level 230D. Once the fill sensor 270 detects the first predetermined fill level 30A, the controller 264 directs the first valve 266 to change to the fully closed position as shown in FIG. 21, which triggers the second stage 1300B of the flush mode 1300.

In the second stage 1300B of the flush mode 1300B, as shown in FIG. 21, the controller 264 directs the doser 262 to continuously dose the fluid in the reservoir 230 into the water supply 220. The doser 262 doses the fluid in the reservoir 230 into the water supply 220 so as to empty the reservoir 230 for refiling with the water treatment solution 222.

The second stage 1300B ends when the fill level sensor 270 detects the third predetermined fill level 230C. Once the third predetermined fill level 230C is detected, the controller 264 directs the valve 266 to the fill position to being refilling the tank 212, and the user is signaled to begin the fill mode 1100.

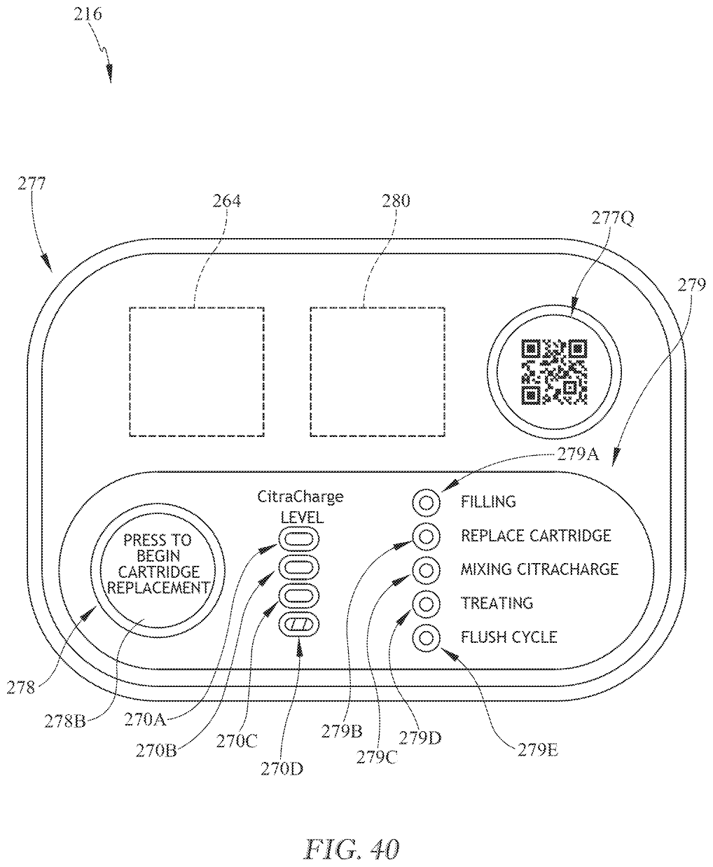

In the illustrative embodiment, the control system 216 includes a user interface 277 as shown in FIG. 40. The user interface 277 is coupled to the controller 264 and is configured to receive inputs from the user. The user interface 277 indicates to the user when the system 210 is in each of the different modes 1100, 1200, 1300 and provides the user with instructions via sounds, lights, digital display, or other similar means of communication to indicate action is needed or underway.

The user interface 277 includes an input system 278 and an output system 279 coupled to the input system 278, and a communication unit 280 coupled to the input and output systems 278, 279 as shown in FIG. 40. The input system 278 and the output system 279 are both coupled to the controller 264 to receive and send information to the controller 264. The communication unit 280 is coupled to the controller 264 and the input and output systems 278, 279 and is configured to receive and send information to a wireless device, such as a smart phone, a tablet, computer, or another suitable device.

In the illustrative embodiment, the user interface 277 includes a QR code 277Q as shown in FIG. 40. The QR code 277Q is configured to be scanned by the user using a wireless device, such as a smart phone, a tablet, computer, or another suitable device. This allows the user to access an app for the wireless device and link the system 210 to a user profile. The system 210 is given a specific device ID as part of the user profile set-up.

The input system 278 is configured to provide the input from the user through a button, a sensor, combination thereof, or any suitable alternative. In the illustrative embodiment, the input system is a fill button 278B, which directs the controller 264 to begin the fill mode 1100 when the user presses the fill button 278B. In other embodiments, the input system 278 may be a button on the app in which the user is able to control the system 210. In some embodiments, the fill button 278 is configured to emit a constant or flashing light.

The output system 279 is configured to provide instructions or information to the user. The output system 279 includes a set of fill level visual indicators 270A, 270B, 270C, 270D and a set of status visual indicators 279A, 279B, 279C, 279D, 279E as shown in FIG. 40. The fill level visual indicators 270A, 270B, 270C, 270D correspond to the fill-level markers of the level sensor 270. The visual indicators 270A, 270B, 270C, 270D, 279A, 279B, 279D, 279E are LED lights in the illustrative embodiment.

The fill level visual indicators 270A, 270B, 270C, 270D are configured to receive a signal from the sensor 270 corresponding to the fill level 230A-230E of the storage reservoir 230. Based on the fill level 30A-30E of the reservoir 230, the visual indicators 270A, 270B, 270C, 270D emit a light to indicate the fill level 30A-30E of the reservoir 30.

In the illustrative embodiment, the fill level visual indicators 270A, 270B, 270C, 270D include a first fill-level indicator 270A, a second fill-level indicator 270B, a third fill-level indicator 270C, and a fourth fill-level indicator 270D as shown in FIG. 40. The first fill-level indicator 270A indicates when the storage reservoir 230 is filled to the maximum volume of the reservoir 230 with the water treatment solution 222. The second fill-level indicator 270B indicates when the storage reservoir 230 contains about 75% of the maximum volume of the reservoir 230. The third fill-level indicator 270C indicates when the storage reservoir 230 contains about 50% of the maximum volume of the reservoir 230. The fourth fill-level indicator 270D indicates when the storage reservoir 230 contains about 25% of the maximum volume of the reservoir 230. In the illustrative embodiment, the fourth fill-level indicator 270D is configured to change to indicated when the storage reservoir 230 contains about 0% of the maximum volume of the reservoir 230.

The controller 264 is configured to direct the first fill-level indicator 270A to turn on when the fill level sensor 270 detects the second predetermined fill level 230B, i.e. 100% of the maximum volume of the storage reservoir 230. The controller 264 is configured to direct the first fill-level indicator 270A to turn off and the second fill-level indicator 270B to turn on when the fill level sensor 70 detects the a fifth predetermined fill level 230E, i.e. 75% of the maximum volume of the storage reservoir 230. The controller 264 is configured to direct the second fill-level indicator 270B to turn off and the third fill-level indicator 270C to turn on when the fill level sensor 270 detects a sixth predetermined fill level 230F, i.e. 50% of the maximum volume of the storage reservoir 30. The controller 264 is configured to direct the third fill-level indicator 270C to turn off and the fourth fill-level indicator 270D to turn on when the fill level sensor 270 detects a seventh predetermined fill level 230G, i.e. 25% of the maximum volume of the storage reservoir 30. The controller 264 is configured to alter the fourth fill-level indicator 270D when the fill level sensor detects the third predetermined fill level 230C, i.e. 0% of the maximum volume of the storage reservoir 230.

When the controller 264 directs one of the fill level indicators 270A, 270B, 270C, 270D to turn on, the corresponding indicator 270A, 270B, 270C, 270D is configured to emit a light to the user. In some embodiments, the indicator 270A, 270B, 270C, 270D may emit a constant light. In other embodiments, the indicator 270A, 270B, 270C, 270D may emit a blinking light. For instance, the fourth-level indicator 270D may change from a constant light to a blinking light when the controller 264 the fill level sensor 270 detects a change from the seventh predetermined fill level 230G to the third predetermined fill level 230C.

In some embodiments, the fill level indicators 270A, 270B, 270C, 270D may emit lights having the same color. In other embodiments, the fill level indicators 270A, 270B, 270C, 270D may emit lights that have different colors or some of the indicators 270A, 270B, 270C, 270D may be the same color while some of the others are different colors.

The status visual indicators 279A, 279B, 279C, 279D, 279E are coupled to the controller 264 and configured to indicate the stage of the system 10. The status visual indicators include a filling indicator 279A, an replace cartridge indicator 279B, a mixing indicator 279C, a treatment mode indicator 279D, and a flush mode indicator 279E as shown in FIG. 40. The each of the indicators 279A, 279B, 279C, 279D, 279E is directed by the controller 264 to emit a light to indicate to the user the mode of the system 210.

In the illustrative embodiment, the controller 264 directs each of the indicators 279A, 279B, 279C, 279D, 279E to emit a blinking light when turned on. In other embodiments, each of the indicators 279A, 279B, 279C, 279D, 279E is configured to emit a continuous light when directed to turn on by the controller 264.

In some embodiments, the indicators 279A, 279B, 279C, 279D, 279E may emit lights having the same color. In other embodiments, the indicators 279A, 279B, 279C, 279D, 279E may emit lights that have different colors or some of the indicators 279A, 279B, 279C, 279D, 279E may be the same color while some of the others are different colors.

After the user scans the QR code 277Q to set up the system 210, the communication unit may emit a sound to the user to indicate it is time to added a new dispenser 214. The user is prompted to press the fill button 278B as the fill button 278 emits a flashing light. Additionally, the app may send the user a notification to insert the new dispenser 214.

The filling indicator 279A is configured to emit a light when the system 210 is in the first stage 1100A of the fill mode 1100. After the user presses the fill button 278B, the controller 264 directs the fill mode indicator 279A to turn on, while the other indicators 279B, 279C, 279D, 279E are directed to remain off.

As the system 210 enters the third stage 11000 of the fill mode 1100, the controller 264 directs the replace cartridge indicator 279B to turn on and turns off the filling indicator 279A. The user then inserts the dispenser 214 into the cartridge mount 228 and the cartridge sensor 272 detects the RFID tag of the dispenser 214. The controller 264 then directs the cartridge-mount lock 276 to change to the unlock mode so that the user can rotate the dispenser 214 to dispenser the water treatment material 224.

Once the third stage 11000 of the fill mode 1100 is completed, the controller 264 directs the replace cartridge indicator 279B to turn off and directs the mixing indicator 279C to turn on. Once the fourth stage 1100D is complete, the controller 264 directs the mixing indicator 279C to turn off and directs the treatment mode indicator 279D to turn on. The treatment mode indicator 279D remains on, until the fill sensor 270 detects the third predetermined fill level 230C and the flush mode 1300 is started.

Once the flush mode 1300 is started, the controller 264 directs the treatment mode indicator 279D to turn off and directs the flush mode indicator 279E to turn on. The flush mode 1300 is completed such that the third predetermined fill level 230C is again detected by the sensor 270. The detection of the third predetermined fill level 230C by the sensor 270 after the flush mode 1300 signals to the controller 264 to direct the flush mode indicator 279E to turn off and to direct the fill button 278B to emit the flashing light. Simultaneously, the controller 264 may direct a speaker to emit an alarm or noise to signal to the user that the storage reservoir 230 is empty and that the fill mode 1100 needs to be initiated.

The communication unit 280 is coupled to the controller 264 and the input and output systems 278, 279 and is configured to use wireless signals to communicate with the user's smart phone, tablet, computer, or another suitable device. The wireless signals may BLUETOOTH®, Wi-Fi, or any other suitable alternative.

After the fill mode 1100 is completed and the fill level sensor 270 detects the second predetermined fill level 230B, the controller 264 is configured to direct the communication unit 280 to send a signal via Wi-Fi to the user's wireless device. The signal indicates, via a phone app or SMS notification, that the storage reservoir 230 is at a 100% fill level and that the treatment mode 1200 is in progress.

During the treatment mode 1200, as the water treatment solution 222 in the reservoir 230 depletes, the controller 264 is configured to direct the communication unit 280 to send signals via Wi-Fi to the user's wireless device indicating the new fill level in the reservoir 230.

The controller 264 is configured to direct the communication unit 280 to send a first signal via Wi-Fi to the user's wireless device indicating that the storage reservoir 230 is at 100% of the maximum volume of the storage reservoir 230 when the fill level sensor 270 detects the second predetermined fill level. Simultaneously, the first fill-level indicator 270A is configured to turn on.

The controller 264 is configured to direct the communication unit 280 to send a second signal via Wi-Fi to the user's wireless device indicating that the storage reservoir 230 is at 75% of the maximum volume of the storage reservoir 230 when the fill level sensor 70 detects the fifth predetermined fill level 230E. Simultaneously, the first fill-level indicator 270A turns off and the second fill-level indicator 270B is configured to turn on.

The controller 264 is configured to direct the communication unit 280 to send a third signal via Wi-Fi to the user's wireless device indicating that the storage reservoir 230 is at 50% of the maximum volume of the storage reservoir 230 when the fill level sensor 270 detects the sixth predetermined fill level 230F. Simultaneously, the second fill-level indicator 270B turns off and the third fill-level indicator 270C is configured to turn on.

The controller 264 is configured to direct the communication unit 280 to send a fourth signal via Wi-Fi to the user's wireless device indicating that the storage reservoir 230 is at 25% of the maximum volume of the storage reservoir 230 when the fill level sensor 270 detects the seventh predetermined fill level 230G. Simultaneously, the third fill-level indicator 270C turns off and the fourth fill-level indicator 270D is configured to turn on.

The controller 264 is configured to direct the communication unit 280 to send a fifth signal via Wi-Fi to the user's wireless device indicating that the storage reservoir 230 is at 0% of the maximum volume of the storage reservoir 230 or empty when the fill level sensor 270 detects the third predetermined fill level 230C. The fifth signal also indicates that the flush mode 1300 is in progress and a new dispenser 214 is needed. In some embodiments, the controller 264 is configured to send the fifth signal to the company to indicate a new dispenser 214 should be sent to the user. Once the user is ready to begin the fill mode 1100, the steps are repeated to create more water treatment solution 222 in the storage reservoir 230.

In the illustrative embodiment, the tank 212, the dispenser 214, and the control system 216 are contained inside a system housing 218 included in the water treatment system 210. The system housing 218 mounts the user interface 277 of the control system 216 so that the user may easily access the user interface 277. The system housing 218 is also configured to limit the user's access to the tank 212. The system housing 218 surrounds the tank 212, the dispenser 214, and the control system 216 as suggested in FIG. 15A.

The water supply 220 is coupled to an inlet 223 and an outlet 225 of a conduit system 221A, 221B included in the system housing 218. The conduit system 221A, 221B splits into a main line 221A and a fill line 221B. The doser 262 is coupled to main line 221A downstream of the inlet 223. The water supply 220 flows through the inlet 223 and a portion of the flow flows to the main line 221A through the doser 262 before flowing to the outlet 225. The other portion of the flow flows to the fill line 221B through the valve 266 to the storage reservoir 230 if the valve 266 is in one of the fill or flush positions. If the valve 266 is in the fully closed position, the entire flow flows through the main line 221A to the outlet 225.

In the illustrative embodiment, the water treatment system further includes a filter 213 as shown in FIG. 15A. The filter 213 is in fluid communication with the water supply 220. The filter 213 is located upstream of the valve 266 on the fill line 221B.

In the illustrative embodiment, the water treatment system 210 my further include a bypass conduit 227 as shown in FIG. 15A. The flow through the conduits 221, 227 may be controlled using a plurality of valves.

In the illustrative embodiment, the water treatment system 210 is coupled to a power supply 215. The power supply 215 may be included in the system 10 in some embodiments. The power supply 215 is configured to supply power to the different components of the system 210.

While the disclosure has been illustrated and described in detail in the foregoing drawings and description, the same is to be considered as exemplary and not restrictive in character, it being understood that only illustrative embodiments thereof have been shown and described and that all changes and modifications that come within the spirit of the disclosure are desired to be protected.

1. A water treatment system for treating a water supply, the water treatment system comprising:
a tank in fluid communication with the water supply to receive a flow of water from the water supply, the tank including a tank housing formed to define a storage reservoir and a cartridge mount coupled the tank housing and formed to include a passageway arranged to open into the storage reservoir;
a dispenser configured to be coupled to the cartridge mount of the tank and configured to dispense a water treatment material into the storage reservoir of the tank; and
a control system configured to produce a water treatment solution in the storage reservoir by combining the water and the water treatment material and configured to dose the water supply with the water treatment solution from the storage reservoir;
wherein the control system comprises a doser in fluid communication with the storage reservoir and the water supply and configured to dose the water supply with the water treatment solution and a controller coupled to the doser and configured to direct the doser to dose a predetermined amount of the water treatment solution into the water supply.

2. The system of claim 1, wherein the dispenser comprises:
a cartridge configured to store the water treatment material, the cartridge including a body formed to include an interior storage region that stores the water treatment material and a neck coupled to the body and formed to include an opening arranged to open into the interior storage region, the neck configured to couple to the cartridge mount of the tank; and
a dispensing system configured to control the dispensing of the water treatment material through the opening in the neck of the cartridge.

3. The system of claim 2, wherein the dispensing system comprises:
an upper valve coupled to the neck of the cartridge and arranged over the opening formed by the neck of the cartridge; and
a lower valve coupled to the upper valve opposite the cartridge at a pivot point and configured to rotate about a rotation axis at the pivot point;
wherein the upper valve is formed to include a plurality of upper openings spaced apart circumferentially about the rotation axis and the lower valve is formed to include a plurality of lower openings spaced apart circumferentially about the rotation axis; and
wherein the dispensing system is configured to change between a closed orientation in which the plurality of lower openings formed in the lower valve are offset from the plurality of upper openings formed in the upper valve so that the plurality of lower openings and the plurality of upper openings are covered to prevent the water treatment material from dispensing through the opening in the neck of the cartridge and an open orientation in which the plurality of lower openings formed in the lower valve are aligned with the plurality of upper openings formed in the upper valve to allow dispensing of the water treatment material through the opening in the neck of the cartridge.

4. The system of claim 1, wherein the cartridge mount of the tank comprises:
a cartridge-mount housing coupled to the tank housing and formed to define the passageway in fluid communication with the storage reservoir;
a gate mounted in the passageway of the cartridge-mount housing and configured to change between a closed position in which the gate blocks as access to the storage reservoir through the passageway and an open position in which the gate allows access to the storage reservoir through the passageway; and
a gate controller coupled to the gate and configured to control movement of the gate between the closed position and the open position.

5. The system of claim 4, wherein the gate controller of the cartridge mount comprises:
a shaft that extends through the cartridge-mount housing along a shaft axis and configured to rotate about the shaft axis;
a gear coupled to an end of the shaft for rotation therewith; and
a gear ring coupled to the cartridge-mount housing and configured to rotate relative to the cartridge-mount housing about the rotation axis, the gear ring configured to rotate in a first direction about the rotation axis from a first position in which the gate is in the closed position to a second position in which the gate is in the open position and a second direction opposite the first direction about the rotation axis from the second positon to the first position; and
wherein the gear is formed to define teeth that mate with teeth formed on the gear ring so that rotation of the gear ring about the rotation axis from the first position to the second position causes the shaft to rotate about the shaft axis to change the gate from the closed position to the open position.

6. The system of claim 5, wherein the control system further comprises:
a cartridge-mount lock coupled the cartridge mount and configured to change between a locked position in which the cartridge-mount lock engages of the gate controller to block rotation of the gate controller between the first position and the second position and an unlocked position in which the cartridge-mount lock is spaced apart from the gate controller to allow rotation of the gate controller between the first position and the second position; and
a cartridge sensor coupled to the cartridge mount of the tank and configured to detect if the dispenser is coupled to the cartridge mount;
wherein the controller is coupled to the cartridge-mount lock and the cartridge sensor and the controller is configured to direct the cartridge-mount lock to move from the locked position to the unlocked position if the cartridge sensor detects the dispenser is coupled to the cartridge mount of the tank.

7. The system of claim 1, wherein the control system further comprises:
an inlet valve in fluid communication with the water supply and configured to vary the flow of water from the water supply to the storage reservoir.

8. The system of claim 7, further comprising
a tank inlet conduit in fluid communication with the water supply and the inlet valve;
a fill conduit in fluid communication with the inlet valve and the storage reservoir; and
a flush conduit in fluid communication with the inlet valve and the storage reservoir, the flush conduit including a nozzle coupled to an end of the flush conduit and configured to spray the flow of water from the water supply;
wherein the inlet valve is configured to change between a fully closed position in which the inlet valve blocks the flow of water through the fill conduit and the flush conduit to prevent water from being supplied to the storage reservoir, a fill position in which the inlet valve directs the flow of water through the fill conduit and blocks the flow of water through the fill conduit, and a flush position in which the inlet valve directs the flow of water through the flush conduit and blocks the flow of water through the fill conduit.

9. The system of claim 8, wherein the control system further comprises:
a level sensor located in the storage reservoir and coupled to the controller, the level sensor configured to measure a fill level of the water treatment solution in the storage reservoir;
wherein the controller is configured to direct the inlet valve to change between the fully closed position, the fill position, and the flush position based on the fill level of the water treatment solution in the storage reservoir measured by the level sensor.

10. The system of claim 1, wherein the control system further comprises:
a mixer located in the storage reservoir and configured to mix the water treatment solution in the storage reservoir to prevent the water treatment solution from settling in the storage reservoir.

11. A dispenser assembly adapted for use in a water treatment system to dispense a water treatment material into a reservoir of water, the dispenser assembly comprising:
a cartridge mount coupled to a tank included water treatment system; and
a dispenser configured to be selectively coupled to the cartridge mount, the dispenser comprising:
a cartridge configured to store the water treatment material, the cartridge including a body formed to include an interior storage region that stores the water treatment material and a neck coupled to the body and formed to include an opening arranged to open into the interior storage region; and
a dispensing system coupled to the cartridge and configured to control the dispensing of the water treatment material through the opening in the neck of the cartridge;
wherein the dispenser is configured to be inserted into the cartridge mount and rotated about a rotation axis in a first direction to cause the dispensing system to change from a closed orientation in which the dispensing system blocks the water treatment material from dispensing through the opening in the neck of the cartridge to an open orientation in which the dispensing system has moved to allow the water treatment material to move through the opening of the cartridge to dispense the water treatment material out of the interior storage region into the reservoir of water and the water treatment material is citric acid.

12. The dispenser assembly of claim 11, wherein the dispensing system comprises:
an upper valve coupled to the neck of the cartridge and arranged over the opening formed by the neck of the cartridge; and
a lower valve coupled to the upper valve opposite the cartridge at a pivot point and configured to rotate about a rotation axis at the pivot point;
wherein the upper valve is formed to include a plurality of upper openings spaced apart circumferentially about the rotation axis and the lower valve is formed to include a plurality of lower openings spaced apart circumferentially about the rotation axis;
wherein the plurality of lower openings formed in the lower valve are offset from the plurality of upper openings formed in the upper valve when the dispensing system is in the closed orientation so that the plurality of lower openings and the plurality of upper openings are covered to prevent the water treatment material from dispensing through the opening in the neck of the cartridge; and
wherein the plurality of lower openings formed in the lower valve are aligned with the plurality of upper openings formed in the upper valve when the dispensing system is in the open orientation to allow dispensing of the water treatment material through the opening in the neck of the cartridge.

13. The dispenser assembly of claim 12, wherein the upper valve is formed to include:
a main body formed to define the plurality of upper openings; and
spring arms that each extend from the main body and each configured to deflect axially relative to the rotation axis from an locked position in which each spring arm engages the lower valve to block rotation of the lower valve while the lower valve is in the closed orientation to an unlocked position in which each spring arm has deflected to allow rotation of the lower valve from the closed orientation to the open orientation.

14. The dispenser assembly of claim 12, wherein the lower valve is formed to include:
a planar body formed to include the plurality of lower openings;
alignment pins that each extend axially from the planar body away from the upper valve relative to the rotation axis, the alignment pins each configured to engage with the cartridge mount to fix the lower valve relative to the cartridge mount when the dispenser is inserted into the cartridge mount; and
guide slots that each extend axially through the planar body relative to the rotation axis and circumferentially at least part way about the rotation axis, the guide slots each configured to receive a portion of one of the spring arms.

15. The dispenser assembly of claim 11, wherein the cartridge mount comprises:
a cartridge-mount housing formed to define a passageway in fluid communication with the reservoir of water included in the water treatment system;
a gate mounted in the passageway of the cartridge-mount housing and configured to change between a closed position in which the gate blocks as access through the passageway and an open position in which the gate allows access through the passageway; and
a gate controller coupled to the gate and configured to control movement of the gate between the closed position and the open position.

16. The dispenser assembly of claim 15, wherein the gate controller of the cartridge mount comprises:
a shaft that extends through the cartridge-mount housing along a shaft axis and configured to rotate about the shaft axis;
a gear coupled to an end of the shaft for rotation therewith; and
a gear ring coupled to the cartridge-mount housing and configured to rotate relative to the cartridge-mount housing about the rotation axis, the gear ring configured to rotate in the first direction about the rotation axis from a first position in which the gate is in the closed position to a second position in which the gate is in the open position; and
wherein the gear is formed to define teeth that mate with teeth formed on the gear ring so that rotation of the gear ring about the rotation axis from the first position to the second position causes the shaft to rotate about the shaft axis to change the gate from the closed position to the open position.

17. The dispenser assembly of claim 16, wherein the dispenser cooperates with the gate controller of the cartridge mount to control dispensing of the water treatment material so that when the dispenser is rotated about the rotation axis in the first direction the dispenser engages the gear ring of the gate controller to cause the gate controller to rotate from the first position to the second position thereby moving the gate from the closed position to the open position.

18. A method of treating a water supply with a water treatment solution, the method comprising:
providing a tank in fluid communication with the water supply and a first dispenser, the tank including a tank housing formed to define a reservoir and a cartridge mount coupled the tank housing and formed to include a tank opening arranged to open into the reservoir, and the first dispenser configured to be coupled to the cartridge mount of the tank and configured to be rotated about an axis to allow the water treatment material to be dispensed out of the first dispenser;
conducting a first flow of water into the reservoir of the tank;
detecting a first predetermined fill level of the liquid in the reservoir and stopping the conducting of the first flow of water into the reservoir when the first predetermined fill level is detected;
dispensing the water treatment material in the first dispenser through the tank opening into the water in the reservoir;
detecting a second predetermined fill level of the liquid in the reservoir and mixing the water and the water treatment material in the reservoir when the second predetermined fill level is detected to produce the water treatment solution configured to react with hard minerals in the water supply to reduce hardness of the water supply; and
dosing a predetermined amount of the water treatment solution into the water supply to reduce the hardness of the water supply.

19. The method of claim 18, wherein the method further comprises:
detecting a third predetermined fill level of the liquid in the reservoir that corresponds to the reservoir being empty;
conducting a second flow of water into the reservoir of the tank to flush out the reservoir after the third predetermined fill level is detected;
detecting a fourth predetermined fill level of the liquid in the reservoir and stopping the conducting of the second flow of water into the reservoir when the fourth predetermined fill level is detected;
dosing the water in the reservoir into the water supply so as to empty the reservoir for refiling with the water treatment solution; and
detecting the third predetermined fill level in the reservoir and stopping the dosing of the water when the third predetermined fill level is detected.

20. The method of claim 18, wherein the method further comprises the steps of:
repeating the steps of:
conducting the first flow of water into the reservoir of the tank;
detecting the first predetermined fill level of the liquid in the reservoir; and
stopping the conducting of the first flow of water into the reservoir when the first predetermined fill level is detected after the step of stopping the dosing of the water when the third predetermined fill level is detected;
removing the first dispenser coupled the cartridge mount of the tank that is empty and coupling a second dispenser that is full to the cartridge mount;
dispensing the water treatment material in the second dispenser through the tank opening into the water in the reservoir; and
repeating the steps of:
detecting the second predetermined fill level of the liquid in the reservoir and mixing the water and the water treatment material in the reservoir when the second predetermined fill level is detected to produce the water treatment solution; and
dosing the predetermined amount of the water treatment solution into the water supply.

21. (canceled)
